(19) United States
(12) Patent Application Publication
(10) Pub. No.: US 2012/0197461 A1
(43) Pub. Date: Aug. 2, 2012

(54) Vision Based Hover in Place

(76) Inventors: Geoffrey Louis Barrows, Washington, DC (US); James Sean Humbert, Bethesda, MD (US); Alison Leonard, Brooklyn, NY (US); Craig William Neely, Vienna, VA (US); Travis Michael Young, Rockville, MD (US)

(21) Appl. No.: 13/078,211

(22) Filed: Apr. 1, 2011

Related U.S. Application Data
(60) Provisional application No. 61/320,718, filed on Apr. 3, 2010.
(60) Provisional application No. 61/361,610, filed on Jul. 6, 2010.
(60) Provisional application No. 61/441,204, filed on Feb. 9, 2011.

(51) Int. Cl. G06F 17/00

(52) U.S. Cl. 701/1

(57) ABSTRACT

A method for providing vision based hover in place to an air vehicle is disclosed. Visual information is received using one or more image sensors on the air vehicle and based on the position of the air vehicle. A number of visual displacements is computed from the visual information. One or more motion values are computed based on the visual displacements. One or more control signals are generated based on the motion values.

### CROSS-REFERENCE TO RELATED APPLICATIONS

This application claims the benefit to U.S. Provisional Patent Applications No. 61/320,718 entitled “Vision Based Hover in Place” and filed Apr. 3, 2010, No. 61/361,610 entitled “Vision Based Hover in Place in Lighted Environment” and filed Jul. 6, 2010, and No. 61/441,204 entitled “Image Sensor” and filed Feb. 9, 2011.

### FEDERALLY SPONSORED RESEARCH

This invention was made with Government support under Contract No. W31P4Q-06-C-0290 awarded by the United States Army and Contract No. FA8651-09-C-0178 awarded by the United States Air Force. The Government has certain rights in this invention.

### TECHNICAL FIELD

The teachings presented herein relate to vision based control of a hovering air vehicle.

### BACKGROUND

A contemporary topic of interest is that of so-called “Unmanned Air Vehicles” (UAVs), or “drone aircraft”. A significant challenge facing such UAVs is providing them with the ability to operate in cluttered, enclosed, and indoor environments with various levels of autonomy. It is desirable to provide such air vehicles with “Hover in Place” (HIP), or the ability to hold a position for a period of time. This capability would allow a human operator to, for example, pilot the air vehicle to a desired location, and release any “control sticks”, at which time the air vehicle would take over control and maintain its position. If the air vehicle were exposed to moving air currents or other disturbances, the air vehicle should then be able to hold or return to its original position. Such a HIP capability would also be beneficial to vehicles traveling in other mediums, for example underwater vehicles and space-borne vehicles.

It is also desirable to provide a HIP capability to smaller vehicles, such as so-called “micro air vehicles” (MAVs) having a maximum dimension of 30 cm or less. The small size of such MAVs implies that their payload capacity is limited, and for smaller vehicles may be on the order of just several grams or less. Implementing any avionics package for a platform of this class is therefore a challenge.

Most contemporary approaches to controlling an air vehicle incorporate the use of an inertial measurement unit (IMU), which typically includes both a three-axis gyro capable of measuring roll, pitch, and yaw rates, and an accelerometer capable of measuring accelerations in three directions. For short periods of time, the pose angles (roll, pitch, and yaw angles) of an air vehicle may be obtained by integrating the respective roll, pitch, and yaw rates over time. Likewise, the velocity of the air vehicle may be obtained by integrating the measured accelerations. The position of the air vehicle may then be obtained by integrating the velocity measurements over time. In practice, these methods can provide useful state estimations for short periods of time ranging from several seconds to a minute, depending on the quality of the IMU gyros and accelerometers. For longer periods of time, factors such as noise and offset will accumulate over time and cause the measured pose and position to diverge from the actual value. This is undesirable in an enclosed environment, where the accumulated error could cause the vehicle to crash into other objects. The effect of offset in accelerometer measurements on position estimate can be particularly drastic, since a constant offset integrated twice results in an error that grows quadratically in time.

In order to solve the task of providing HIP, inspiration may be drawn from biology. One biologically inspired method of providing such relative depth information is with the use of optical flow. Optical flow is the apparent visual motion seen from a camera or eye that results from relative motion between the camera and other objects or hazards in the environment. For an introduction to optical flow including how it may be used to control air vehicles, refer to the paper, which shall be incorporated herein by reference, entitled “Biologically inspired visual sensing and flight control” by Barrows, Chahl, and Srinivasan, in the Aeronautical Journal, Vol. 107, pp. 159-168, published in 2003. Of particular interest is the general observation that flying insects appear to hover in place by keeping the optical flow zero in all directions. This rule is intuitively sound, since if the optical flow is zero, then the position and pose of the insect relative to other objects in the environment is unchanging, and therefore the insect is hovering in place. An initial implementation of this basic control rule for providing a helicopter with HIP is disclosed in the paper, the contents of which shall be incorporated herein by reference, entitled “Visual control of an autonomous helicopter” by Garratt and Chahl and published in the proceedings of the AIAA 41st Aerospace Sciences Meeting and Exhibit, 6-9 Jan. 2003, Reno, Nev. In this implementation a stereo vision system aimed downwards is used to measure the helicopter's altitude while optical flow is used to measure and control lateral drift.

One characteristic of flying insects is that they have compound eyes that are capable of viewing the world over a wide field of view, which for many insects is nearly omnidirectional. They therefore sense optical flow over nearly the entire field of view. Furthermore, in some insects there have been identified neural cells that are capable of extracting patterns from the global optical flow field. This work has inspired both theoretical and experimental work on how to sense the environment using optical flow and then use this information to control a vehicle. The following collection of papers, which shall be incorporated herein by reference, describes this work in detail: “Extracting behaviorally relevant retinal image motion cues via wide-field integration” by Humbert and Frye, in the proceedings of the American Control Conference, Minneapolis Minn. 2006; the chapter “Wide-field integration methods for visuomotor control” by Humbert, Conroy, Neely, and Barrows in Flying Insects and Robotics, D. Floreano et al (eds.) Springer-Verlag Berlin Heidelberg 2009; “Experimental validation of wide-field integration methods for autonomous navigation” by Humbert, Hyslop, and Chinn, in the proceedings of the 2007 IEEE Intelligent Robots and Systems (IROS) conference; “Autonomous navigation in three-dimensional urban environments using wide-field integration of optic flow” by Hyslop and Humbert in the AIAA Journal of Guidance, Control, and Dynamics, Vol. 33, No. 1, January-February 2010; “Wide-field integration methods for autonomous navigation of 3-D environments” by Hyslop and Humbert in the proceedings of the AIAA Guidance, Navigation, and Control Conference and Exhibit, 18-21 Aug. 2008, Honolulu, Hi.; and “Bio-inspired visuomotor convergence” by Humbert and Hyslop in IEEE Transactions on Robotics, Vol. 26, No. 1, February 2010. A common theme to these papers is the spatial integration of optical flow over a wide field of view. These set of techniques may be referred to by the term “wide field integration”.

There are various methods of obtaining a wide field of view image of the environment suitable for optical flow processing. One method is described in the published patent application 20080225420 entitled “Multiple Aperture Optical Systems” by Barrows and Neely, which shall be incorporated herein by reference. This patent application discloses an array of vision sensors mounted on a flexible substrate that may be bent into a circle to image over a circular 360 degree field of view. Other methods include the use of a camera and a curved mirror, where the camera is pointed at the mirror in a way that the observed reflection covers a wide field of view. An example system is described in U.S. Pat. No. 5,790,181 entitled “Panoramic surveillance system” by Chahl et al, which shall be incorporated herein by reference.

Many methods exist for computing optical flow in a compact package. Applicable references, all of which shall be incorporated herein by reference, include U.S. Pat. No. 6,194,695 entitled “Photoreceptor array for linear optical flow measurement” by Barrows; U.S. Pat. No. 6,384,905 entitled “Optic flow sensor with fused elementary motion detector outputs” by Barrows; U.S. Pat. No. 7,659,967 entitled “Translational optical flow sensor” by Barrows; the paper “An image interpolation technique for the computation of optical flow and egomotion” by Srinivasan in Biological Cybernetics Vol. 71, No. 5, pages 401-415, September 1994; and the paper “An iterative image registration technique with an application to stereo vision” by Lucas and Kanade, in the proceedings of the Image Understanding Workshop, pages 121-130, 1981.

Two additional books that serve as reference material in the fields of optics and image processing include the book “Digital Image Processing, Third Edition”, by R. Gonzalez and R. Woods, published by Pearson Prentice Hall in 2008 and the book “Optical Imaging and Spectroscopy” by D. Brady, published by Wiley in 2009. Both books are incorporated herein by reference.

Since vision systems are a major part of the teachings included herein, we will now discuss the prior art of image sensors. An image sensor is a device that may be used to acquire an array of pixel values based on an image focused onto it. Image sensors are often used as part of a camera system comprising the image sensor, optics, and a processor. The optics projects a light image onto the image sensor based on the environment. The image sensor contains an array of pixel circuits that divides the light image into a pixel array. The pixel array may also be referred to as a “focal plane” since it generally may lie at the focal plane of the optics. The image sensor then generates the array of pixel values based on the light image and the geometry of the pixel circuits. The processor is connected to the image sensor and acquires the array of pixel values. These pixel values may then be used to construct a digital photograph, or may be processed by image processing algorithms to obtain intelligence on the environment.

In the late 20th Century, techniques were developed to fabricate image sensors on a chip using standard CMOS (complementary metal-oxide-semiconductor) integrated circuit fabrication techniques. The book “CMOS Imagers: From Phototransduction to Image Processing”, edited by Orly Yadid-Pecht and Ralph Etienne-Cummings, published by Kluwer Academic Publishers in 2004 is a reference on this art. The contents of this book are incorporated herein by reference.

In the teachings below, we will use the “C programming language convention” of indexing rows and columns starting with zero. For example, the top-most row will be referred to as “row 0” while the second row as “row 1” and so on. Similarly, the left-most column will be referred to as “column 0” and the second column as “column 1” and so on. We will use the notation (r,c) to refer to an element at “row r” and “column c”. This convention will generally be used for all two-dimensional arrays of elements. When referring to a digital signal, we will generally use the terms “high” and “low” to respectively indicated a digital “one” or digital “zero”. A signal that “pulses high” is a signal that starts out a digital zero, rises to a digital one for a short time, and then returns to digital zero. A signal that “pulses low” similarly is a signal that starts out a digital one, falls to a digital zero for a short time, and then returns to a digital one.

We will now describe the design of a prior art image sensor that may be manufactured in an integrated circuit. Refer to FIG. 1A, which depicts a logarithmic response pixel circuit 101. This circuit comprises a photodiode D1 103 and a transistor M1 105. Transistor M1 105 may be an N-channel MOSFET (metal-oxide-semiconductor field effect transistor) in an N-well/P-substrate process. Transistor M1 105 as shown is “diode connected” so that it's gate and it's drain are connected together and tied to the positive voltage supply 107. Diode D1 103 sinks to Ground 109 an amount of current corresponding to the amount of light striking it. As more light strikes D1 103, more current flows through M1 105. Transistor M1 105 typically operates in the subthreshold region. Therefore the voltage drop across M1 105 is an approximately logarithmic function of the amount of current flowing through it when diode-connected as shown. Therefore the voltage at the output 111 varies logarithmically with the amount of light striking D1 103, with more light resulting in a lower output voltage. An amplifier circuit or a buffer circuit (not shown) reads off this output voltage for use in other circuitry. Various amplifier circuits and means of reading out values from an array of these pixel circuits may be found in the aforementioned book by Yadid-Pecht and Etienne-Cummings.

The pixel circuit 101 of FIG. 1A may be modified by increasing the number of diode-connected transistors. Refer to FIG. 1B, which shows a logarithmic response pixel circuit 121 with two diode-connected transistors M1 123 and M2 125. The pixel circuit 121 of FIG. 1B operates similarly as that of FIG. 1A except that the use of two transistors increases the voltage drop. The pixel circuit 121 of FIG. 1B may produce twice the voltage swing as circuit 101 of FIG. 1A, but may require a higher supply voltage as a result of the use of two transistors. The pixel circuit 121 of FIG. 1B may be modified to use three or more diode connected transistors.

Refer to FIG. 1C, which depicts the cross section 141 of an implementation of a photodiode that may be made in an N-well P-substrate CMOS process. Diode symbol 143 shows the equivalent electrical schematic of the photodiode formed in the cross section 141. This diode may be utilized in the pixel circuits of FIGS. 1A and 1B. The diode is formed between the P-doped substrate 145, labeled “p−”, and an N-well 147, labeled “n−”. The substrate 145 is tied to Ground 146 via a substrate contact 149, which can be accessed via a P-diffusion area 151, labeled “p+”. The “P” side 148 of the diode is therefore tied to ground 146. The other end 153 of the diode may be accessed via an N-diffusion area 155, labeled “n+”. It will be understood that the cross section 141 shown in FIG. 1C is for illustrative purposes only and that photodiodes may be constructed using other techniques that are well known in the published art.

FIG. 2A shows the block diagram of a prior art image sensor 201. A focal plane circuit 203 contains an array of pixel circuits such as the pixel circuit 101 of FIG. 1A. The schematic diagram of this pixel circuit will be discussed below. The multi-bit digital signals RS 205 and CS 207 respectively specify a single pixel value to be read out from the focal plane circuit 203. RS 205 and CS 207 each contain the number of bits necessary to specify respectively a row and column of the focal plane circuit 203. A pixel row select circuit 209 receives as input RS 205 and generates an array of row select signals 211. Pixel row select circuit 209 may be constructed using a decoder circuit. The signal corresponding to the row of pixels selected by RS 205 is set to a digital high, while other signals are set to a digital low. The focal plane circuit 203 connects the selected row of pixel circuits to output column lines 213, which form the output of the focal plane circuit 203. A row readout circuit 215 electronically buffers or amplifies the column signals 213 to form buffered column signals 217. A column select circuit 219 is a multiplexer circuit that selects one of the buffered column signals 217 based on CS 207 for amplification and output. A final amplifier circuit 221 buffers the selected column signal 223 to form the output 225 of the image sensor 201, which will be an electrical signal based on the pixel of the focal plane 203 selected by RS 205 and CS 207. An optional analog to digital converter (ADC) (not shown) then may digitize the selected pixel signal. Amplifier circuit 221 may be a buffer amplifier, or may have a gain, but it is beneficial for the amplifier circuit 221 to have an adequately low output impedance to drive any desired load including, for example, an ADC.

FIG. 2B shows the circuit diagram of the focal plane 203 and the row readout circuits 215 of FIG. 2A. The circuit of FIG. 2B shows a pixel array 231 with two rows and three columns of pixels, which may be used to implement the focal plane 203 and the row readout circuits 215. This array 231 may be expanded to any arbitrary size. Diode D1 233 and transistor M1 235 form a basic pixel circuit 101 like that shown in FIG. 1A. The voltage generated by D1 233 and M1 235 at node 237 is provided to the gate of transistor M2 239. The voltage at node 237 may be referred to as a “pixel signal”. Row select signals “rs0” 241 and “rs1” 243 may be the first two row select signals 211 as shown in FIG. 2A. When RS=0, row select signal “rs0” 241 becomes a digital high (and “rs1” 243 a digital low), then transistor M3 249 is turned on and becomes the equivalent of a closed switch. If transistor M4 245 is provided with an adequate bias voltage 247 at its gate, transistor M2 239 and M4 245 form a source follower circuit. The output signal “col0” 251 in this case contains a buffered version of the pixel signal voltage 237 generated by D1 233 and M1 235. Transistors M1 235, M2 239, and M3 249 and diode D1 233 form a pixel circuit cell 234 that may be replicated across the entire array 231. Signals “col1” 253 and “col2” 255 will similarly contain buffered versions of pixel signals generated by the other two pixel circuits on the first row of the pixel array. If RS=1, then “rs0” 241 becomes instead set to a digital low while “rs1” 243 is set to a digital high, and then the second row of three pixel signals will similarly be buffered and sent out to “col0” 251, “col1” 253, and “col2” 255. Lines “col0” 251, “col1” 253, and col2 “255” may be referred to as “column output lines”, and the electrical signals on them may be referred to as “column output signals”. The row readout transistors M3 (e.g. 249) and the column bias transistors (e.g. 245) connected to column signals “col0” 251, “col1” 253, and “col2” 255 effectively form the array of row readout circuits 215. Column signals “col0” 251, “col1” 253, and “col2” 255 form the output column lines 213. Note that when the circuit of FIG. 2B is used, the column lines 213 and buffered columns lines 217 are identical.

The image sensor 201 may be read out using the following algorithm, expressed as pseudocode, to acquire an image and store it in the two dimensional (2D) matrix IM. Variables NumRows and NumColumns respectively denote the number of rows and columns in the focal plane 203. It will be understood that since the pixel circuits of FIGS. 1A and 1B output a lower voltage for brighter light, the values stored in matrix IM may similarly be lower for brighter light. The algorithm below assumes the use of an ADC (analog to digital converter) to obtain a digital value from the output 225.

| | |
|---|---|
| for row = 0 ... | (NumRows−1) // Loop through every row |
| | set RS = row; |
| | delay; // insert enough delay to let analog signals settle |
| | for col = 0 ... (NumColumns−1) // Loop through every |
| | column |
| | set CS = col; |
| | delay; // insert delay to let ADC capture signal |
| | IM(row,col) = digitize_pixel( ); // performed using |
| | an ADC |
| | end |
| end | |

Refer to FIG. 2C, which depicts a generic prior art camera 281 that may be formed using an image sensor of the type shown in FIGS. 2A and 2B. An image sensor chip 283 may be wire bonded to a circuit board 285 using wire bonds 287. These wire bonds 287 provide power to the image sensor 283 as well as a connection for input and output signals. The image sensor chip 283 may contain image sensor circuitry of the type shown in FIGS. 2A and 2B. An optical assembly 289 may be placed over the image sensor 283 to cover it. The optical assembly 289 may contain a lens bump 291, shaped appropriately to focus light 293 from the environment onto the image sensor chip 283. The optical assembly 289 may also contain an opaque shield 295 so that the only light reaching the image sensor chip 283 is through the lens bump 291. A processor 297 may also be mounted onto the circuit board 285 and connected in a way to interface with the image sensor chip 283. The camera 281 shown in FIG. 2C is one of many possible configurations. It will be understood that other variations are possible, including low profile cameras described in the published US Patent Application 2011/0026141 by Barrows entitled “Low Profile Camera and Vision Sensor”, the contents of which are incorporated herein by reference. It will be understood that one characteristic of many camera systems is that the image focused onto any focal plane is flipped both vertically and horizontally as a result of being focused by the lens. Therefore it will be understood that in any discussion of the use of an image sensor to acquire imagery from the visual environment for processing, this flipping is accounted for in the storage, indexing, and/or processing of the pixels in the memory of any processor.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts a logarithmic response pixel circuit;

FIG. 1B shows a logarithmic response pixel circuit with two diode-connected transistors;

FIG. 1C depicts the cross section of an implementation of a photodiode;

FIG. 2A shows the block diagram of a prior art image sensor;

FIG. 2B shows the circuit diagram of the focal plane and the row readout circuits of FIG. 2A;

FIG. 2C depicts a generic prior art camera;

FIG. 3 depicts a first exemplary image sensor;

FIG. 4 depicts a single row amplifier circuit;

FIG. 5 depicts an exemplary construction of the switched capacitor array;

FIG. 6 shows how horizontal switch signals H1 through H8 and V1 through V8 may be connected to the switched capacitor array;

FIG. 7 depicts a second exemplary image sensor with shorting transistors in the focal plane array;

FIG. 8 depicts the circuitry in the focal plane array of the second exemplary image sensor;

FIG. 9 depicts a two capacitor switched capacitor cell;

FIG. 10 shows a two transistor switching circuit;

FIG. 11A depicts a rectangular arrangement of pixels;

FIG. 11B depicts a hexagonal arrangement of pixels;

FIG. 11C shows how each switched capacitor cell would be connected to its six neighbors in a hexagonal arrangement;

FIG. 12 depicts an exemplary algorithm for computing optical flow;

FIG. 13A shows a vision sensor with an LED;

FIG. 13B depicts an optical flow sensor mounted on a car;

FIG. 14 shows a coordinate system;

FIG. 15A shows an optical flow pattern resulting from forward motion;

FIG. 15B shows an optical flow pattern resulting from motion to the left;

FIG. 15C shows an optical flow pattern resulting from motion upward;

FIG. 15D shows an optical flow pattern resulting from yaw rotation;

FIG. 15E shows an optical flow pattern resulting from roll rotation;

FIG. 15F shows an optical flow pattern resulting from pitch rotation;

FIG. 16A shows a sample sensor ring arrangement of eight sensors;

FIG. 16B shows an exemplary contra-rotating coaxial rotary-wing air vehicle;

FIG. 17 shows a block diagram of an exemplary vision based flight control system;

FIG. 18A shows the first exemplary method for vision based hover in place;

FIG. 18B shows a three part process for computing image displacements;

FIG. 19 depicts a block of pixels being tracked;

FIG. 20 shows the top view of an air vehicle surrounded by a number of lights;

FIG. 21 shows a side-view of the same air vehicle;

FIG. 22 shows a pixel grid;

FIG. 23A shows subpixel refinement using polynomial interpolation;

FIG. 23B shows subpixel refinement using isosceles triangle interpolation;

FIG. 24 shows an exemplary samara air vehicle;

FIG. 25 depicts an omnidirectional field of view;

FIG. 26 shows an omnidirectional image obtained from a vision sensor as an air vehicle rotates; and

FIG. 27 shows two sequential omnidirectional images and their respective subimages.

### DESCRIPTIONS OF EXEMPLARY EMBODIMENTS

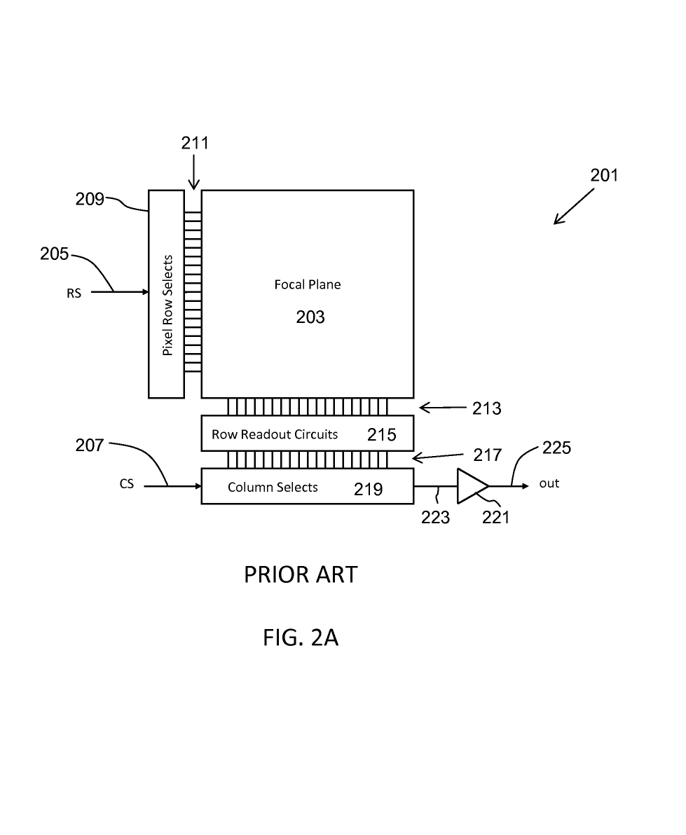

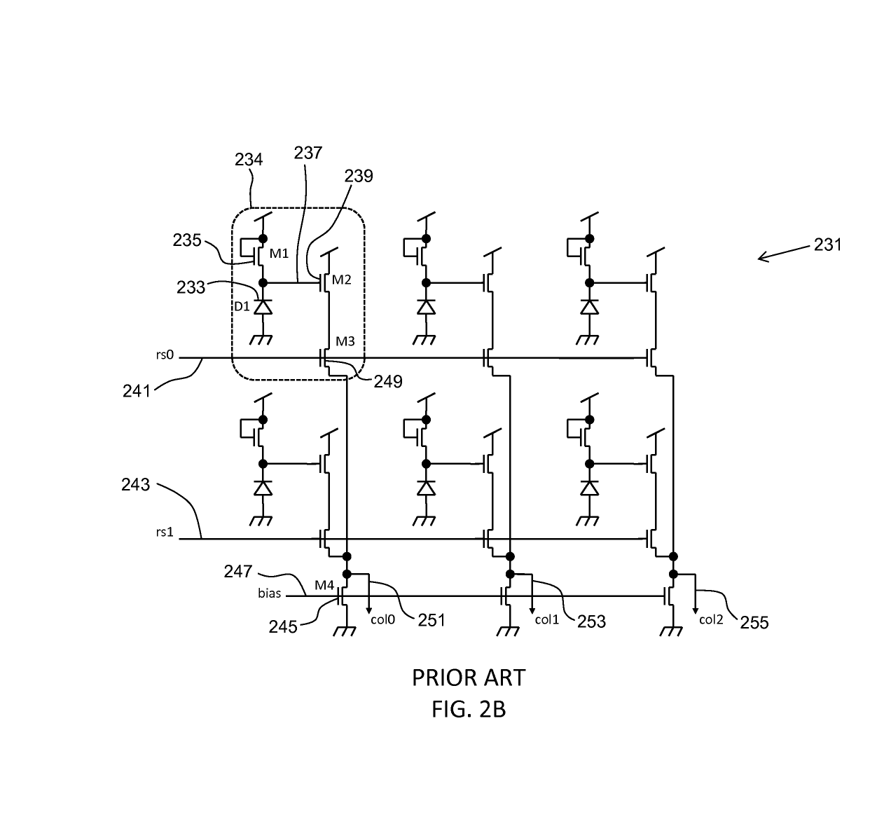

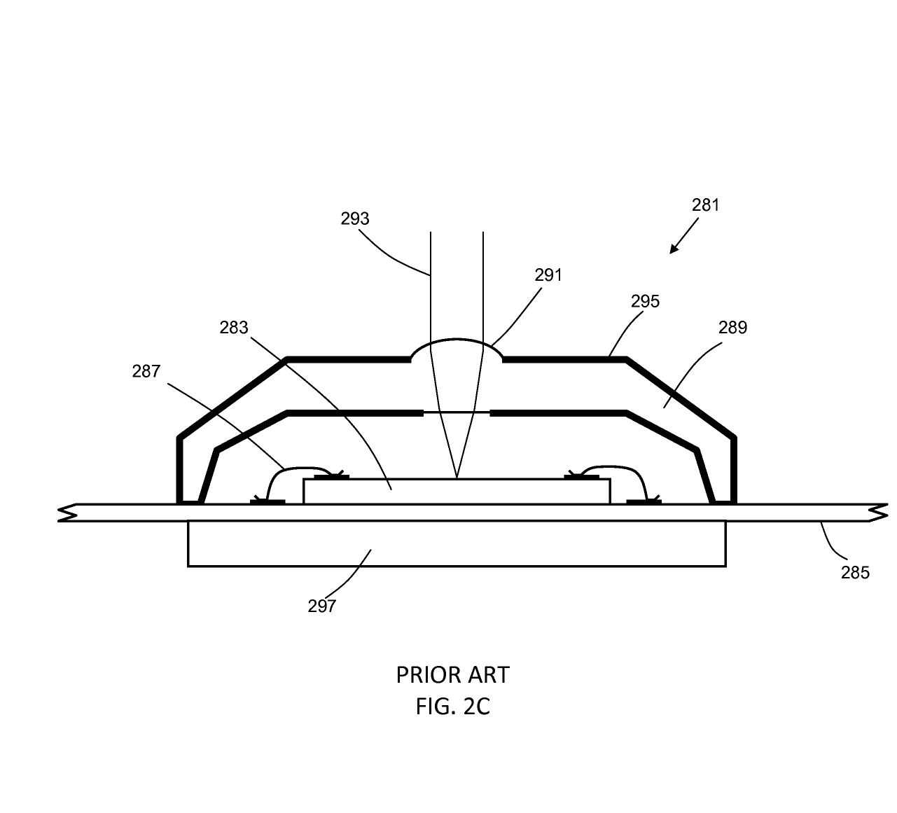

We will now describe a number of exemplary embodiments for an image sensor. All of these embodiments may be implemented in a single integrated circuit to form an image sensor chip which may be used in a camera such as camera 281 of FIG. 2C.

First Exemplary Image Sensor

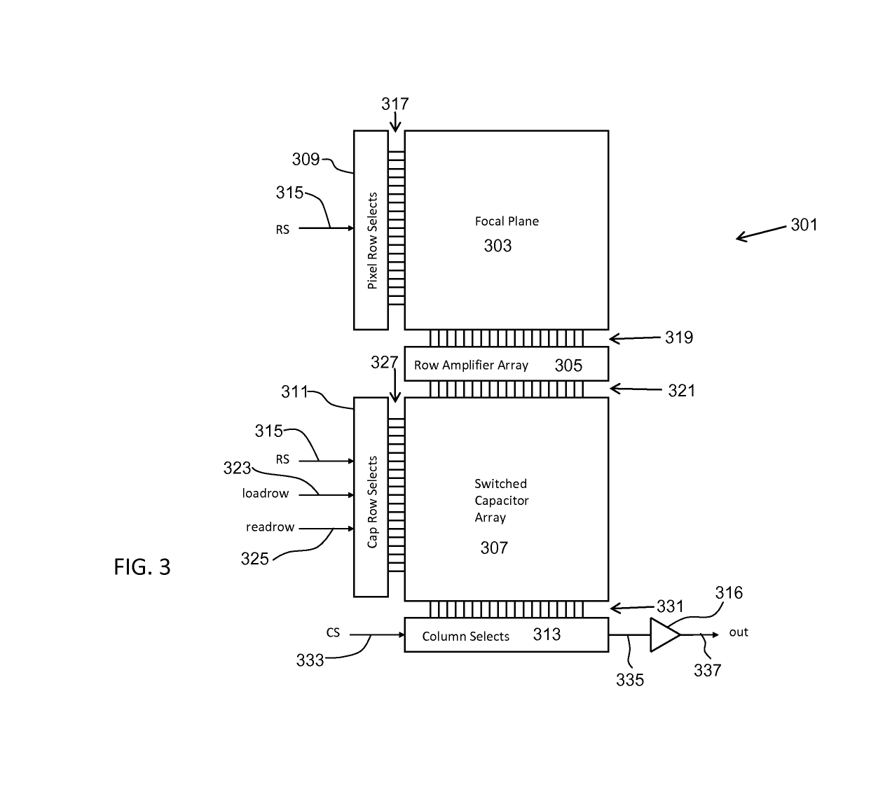

Refer to FIG. 3, which depicts a first exemplary image sensor 301. This image sensor 301 comprises a focal plane 303, a row amplifier array 305, and a switched capacitor array 307. This image sensor 301 also comprises a pixel row select circuit 309, a capacitor row select circuit 311, a column select circuit 313, and an output amplifier 316.

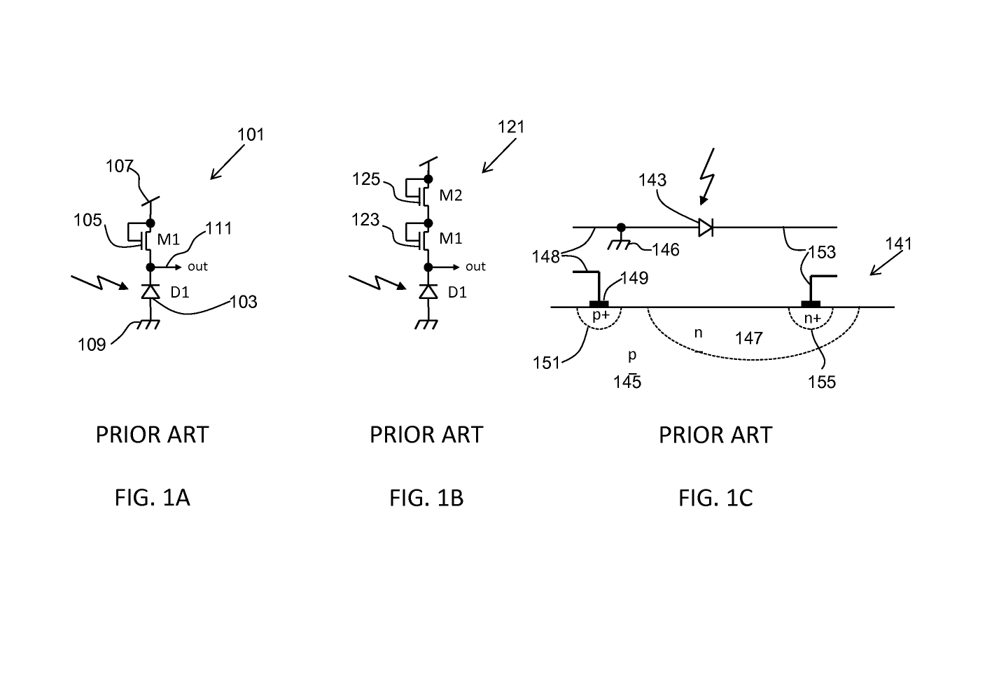

The focal plane circuit 303 may be constructed in the same manner as the pixel array 231 of FIG. 2B including the column bias transistors (e.g. 245) so as to generate a buffered output. In this case the column signals 319 and the buffered column signals 321 would be identical. The focal plane circuit 303 may be constructed with the pixel circuits of FIGS. 1A, 1B, or other variations. The pixel row select circuit 309 receives as input a multi-bit row select word RS 315 and generates row select signals 317 in the same manner as the image sensor 201 of FIGS. 2A and 2B. The focal plane circuit 303 also generates an array of column signals 319 in the same manner as the focal plane circuit 203 of FIG. 2B. The column signals 319 are then provided to a row amplifier array 305, the operation of which will be described below. The row amplifier array 305 generates a corresponding array of amplified column signals 321 which are then provided to the switched capacitor array 307.

The capacitor row select circuit 311 receives as input the aforementioned digital word RS 315 and two additional binary signals “loadrow” 323 and “readrow” 325, and generates an array 327 of capacitor load signals and capacitor read signals. The switched capacitor array 307 receives as input the amplified column signals 321 and the array 327 of capacitor load signals and capacitor read signals. The switched capacitor array 307 also receives as input an array of horizontal switching signals (not shown) and an array of vertical switching signals (not shown). The switched capacitor array 307 also generates an array of capacitor column signals 331, which are sent to the column select circuit 313. The operation of the capacitor row select circuit 311 and the switched capacitor array 307 will be discussed below.

The column select circuit 313 operates in a similar manner as the column select circuit 219 of FIG. 2A, and selects one of the capacitor column signals 331 as an output 335 based on multi-bit column select word CS 333. The amplifier 316 buffers this signal 335 to generate an output 337, which may be sent to an ADC or another appropriate load.

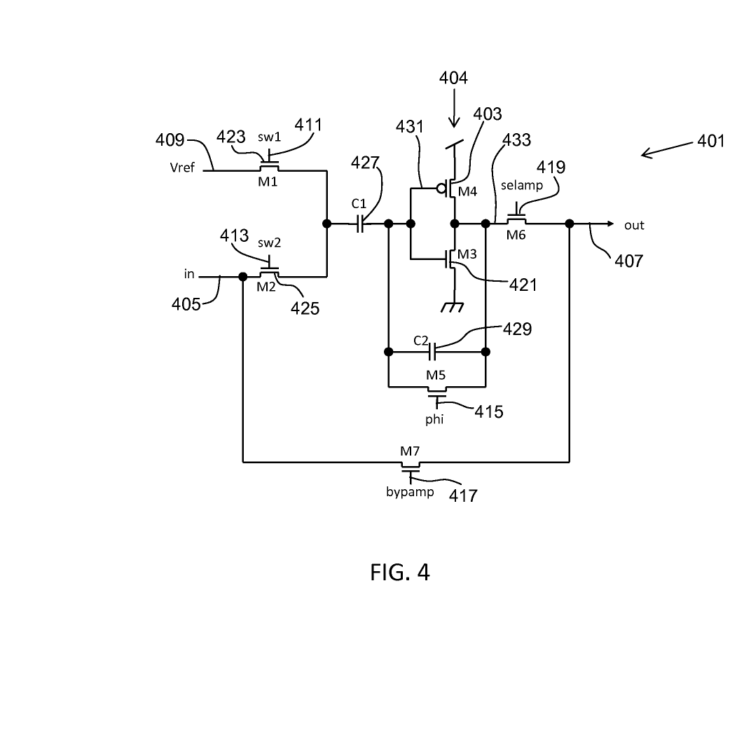

Refer to FIG. 4 which depicts a single row amplifier circuit 401. The row amplifier array 305 contains one row amplifier circuit 401 for each column of the focal plane 303. Transistor M4 403 may be a P-channel MOSFET (metal-oxide-semiconductor field effect transistor) in an N-well/P-substrate process. The other transistors in circuit 401 may be N-channel MOSFET transistors. The input signal “in” 405 is connected to one of the column signals 319 generated by the focal plane circuit 303. The output signal “out” 407 becomes the corresponding amplified column signal of the amplified column signal array 321. Signal “Vref” 409 serves as a reference voltage. Signals “sw1” 411, “sw2” 413, “phi” 415, “bypamp” 417, and “selamp” 419 are global signals that operate all row amplifier circuits in the row amplifier array 305 concurrently and in parallel. When signal “bypamp” 417 is set to digital high and “selamp” 419 is set to digital low, the input signal 405 is sent directly to the output 407. In this case, the column signals 319 generated by the focal plane 303 are sent directly to the switched capacitor array 307.

When signal “bypamp” 417 is set to digital low and “selamp” 419 is set to digital high, the remaining components of the amplifier circuit 401 may be used to amplify the input signal “in” 405. Transistors M3 421 and M4 403 form an inverter 404. Transistors M1 423 and M2 425 are switches that connect the left side of capacitor C1 427 to either “Vref” 409 or “in” 405. Capacitor C2 429 is a feedback capacitor. The amplifier circuit 401 may then be operated as follows: First set “phi” 415 to a digital high, so that the inverter input 431 and the inverter output 433 are shorted together. Second set “sw1” 411 to a digital high and “sw2” 413 to a digital low, so that the left end of capacitor C1 427 is connected to “Vref” 409. Third set “phi” 415 to a digital low, so that the input 431 and output 433 of the inverter 404 are no longer shorted together. Fourth, set “sw1” 411 to a digital low and “sw2” 413 to a digital high, so that the left end of C1 427 is connected to the input voltage “in” 405. Fifth, wait for a short settling duration. After this duration, the output voltage at “out” 407 will be approximately equal to the value:

$$out = \frac{C 1}{C 2} ( in - Vref ) + K$$

where K is a constant voltage depending on the geometry of the transistors and capacitors in circuit 401 and on the fabrication process used to manufacture the image sensor 301. By choosing the ratio of C1 427 to C2 429, it is possible to select the gain of the amplifier 401. By selecting the voltage Vref 409, it is possible to shift the output voltage up or down and compensate for values of K or for changing global light levels.

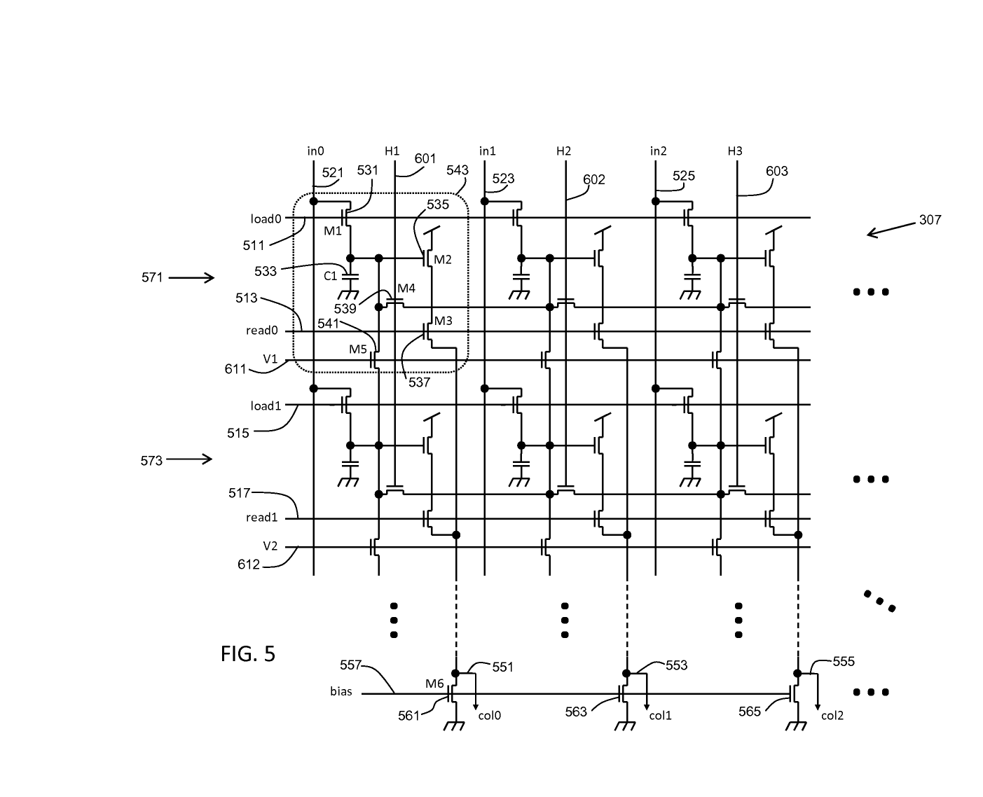

Refer to FIG. 5, which depicts an exemplary construction of the switched capacitor array 307. Only the first two rows and first three columns of the switched capacitor array 307 are shown in the FIG. 5; the entire array 307 may be constructed by extending the shown circuit diagram in both row and column directions. Let us first set signals H1 601, H2 602, H3 603, . . . , V1 611, V2 612, . . . all to digital low. Let us first assume that the value RS=0, so that the focal plane 303 is generating column signals based on the first row of pixel circuits in the focal plane 303, and that the row amplifier array 305 is generating the array of amplified column signals 321 as described above. Transistors M1 531, M2 535, M3 537, M4 539, and M5 541 and capacitor C1 533 form a switched capacitor cell 543, which is replicated across the entire switched capacitor array 307. There may be as many rows and columns of switched capacitor cells in the switched capacitor array 307 as there are pixels in the focal plane 303.

When signal “load0” 511 is pulsed high, capacitor C1 533 stores a voltage equal to the “in0” signal 521. (We define “pulsed high” as setting a signal to a digital high for a short time and then returning the signal to a digital low.) Similarly, the capacitors of all the other switched capacitor cell in the first row 571 (e.g. “row 0”) store the other respective amplified column signals 321. Essentially the topmost row 571 of switched capacitor cells stores a “snapshot” corresponding to the light focused on the topmost row of pixel circuits in the focal plane 303.

Let us next set RS=1, so that the focal plane 303 is outputting the second row (e.g. “row 1”) of pixel signals, and then operate the row amplifier array 305 as described above. When signal “load1” 515 is pulsed high, the capacitors in the second row 573 (e.g. “row 1”) of the switched capacitor cells will store potentials corresponding to row 1 of pixel signals. This process can be repeated for the remaining rows in the focal plane 303 and switched capacitor array 307. After all rows have been accordingly processed, the capacitors in the switched capacitor array 307 store a sampling or a “snapshot” of the amplified column signals 321 generated according to the pixel signals of the focal plane 303. These capacitors effectively store an image. This process of cycling through all rows of the focal plane 303 and the switched capacitor array 307 to deposit a sampled image onto the capacitors of the switched capacitor array 307 may be referred to hereinafter as “the capacitor array 307 grabbing an image from the focal plane 303”.

Once the capacitor array 307 has grabbed an image from the focal plane 303, the image may be read out as follows: First, set signal “read0” 513 to a digital high. This closes the switch formed by transistor M3 537 and forms a source follower with M2 535 and M6 561 to read out the potential stored across capacitor C1 533. The entire “row 0” 571 of switched capacitor cells is similarly selected by “read0” 513. The column select circuit 311 (of FIG. 3) and the amplifier 316 may then cycle through all columns to read out and output the potentials of all capacitors in “row 0” 571 of the switched capacitor array 307. Then “read0” 513 may be set to a digital low, and “read1” 517 may be set to a digital high, and then the potentials across “row 1” 573 may be similarly read out. The remaining rows of the switched capacitor array 307 may be similarly read out in the same fashion. In FIG. 5, the signals “col0” 551, “col1” 553, and onward are members of the capacitor column signal array 331 outputs.

We may now define how the capacitor row select circuit 311 functions: When RS 315 is set to the value i (i is an integer), the respective signal “loadi” (of FIG. 5) will be digital high whenever “loadrow” 323 is digital high, and the signal “readi” will be digital high whenever “readrow” 325 is digital high. Thus row 0 (571) of the switched capacitor array 307 may be loaded by setting RS=0 and pulsing high the “loadrow” 323 signal. Similarly row 0 (571) may be read out by setting RS=0 and pulsing high the “readrow” 325 signal. It is possible to both load a row and read out a row at the same time. It will be clear to those with basic knowledge of digital electronics how to construct such a circuit using a single decoder circuit and an array of AND gates, one for each “loadi” and “readi” signal.

So far we have only discussed transistors M1 531, M2 535, and M3 537 of each switched capacitor cell. We had assumed that since signals H1 601, H2 602, H3 603, . . . , and signals V1 611, V2 612, . . . are digital low, transistors M4 539 and M5 541 (and their replicates in other switched capacitor cells) behave as open switches and are thus equivalently ignored. Note that transistor M4 (e.g. 539) of each switched capacitor cell connects the capacitors of two horizontally adjacent switched capacitor cells. Also note that transistor M5 (e.g. 541) of each switched capacitor cell connects the capacitors of two vertically adjacent switched capacitor cells. We can refer to the M4 and the M5 transistors of the switched capacitor cells respectively as “horizontally shorting switches” and “vertically shorting switches”. Similarly signals H1 601, H2 602, and so on may be referred to as “horizontal switch signals” and signals V1 611, V2 612, and so on may be referred to as “vertical switch signals”. Note also that signal H1 601 closes the M4 transistors between columns 0 and 1, signal H2 602 closes the M4 transistors between columns 1 and 2, and so on. Note also that signal V1 611 closes the M5 transistors between rows 0 and 1, signal V2 612 closes the M5 transistors between rows 1 and 2, and so on.

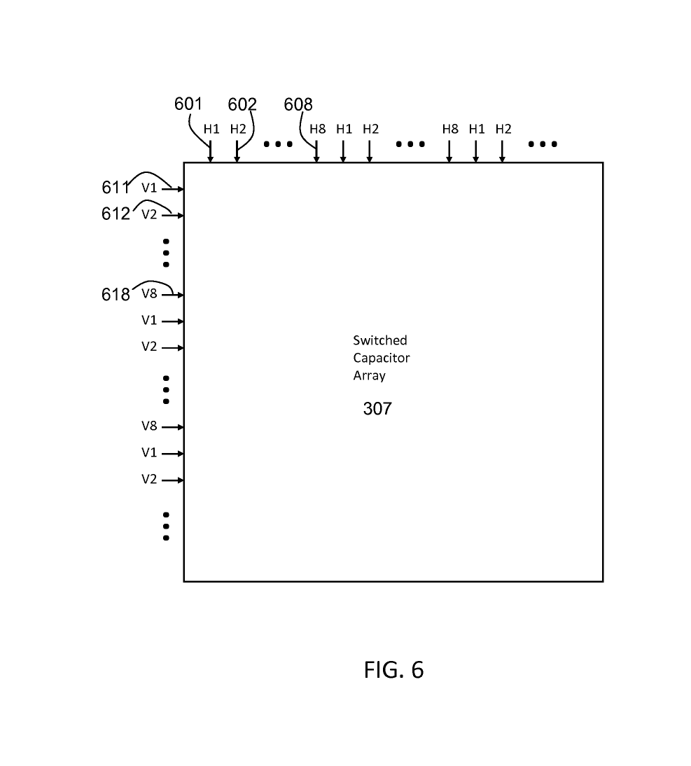

Refer to FIG. 6, which shows how horizontal switch signals H1 601 through H8 608 and V1 611 through V8 618 may be connected to the switched capacitor array 307. For array sizes having more than 8 rows, more than 8 columns, or both, the horizontal switching signals may be repeated so that H1 601 shorts together columns 0 and 1, shorts together columns 8 and 9, and so on. The vertical switching signals may be similarly repeated. This arrangement allows the switching of a large switched capacitor array to be dictated by just 16 binary values, 8 binary values for H1 601 through H8 608 and 8 binary values for V1 611 through V8 618. For purposes of discussion we shall assume the use of these 16 binary values as shown in FIG. 6, though it will be understood that other arrangements are possible.

For this next discussion, we will now use the aforementioned notation (r,c) to denote “row r” and “column c” of an array. Referring back to the circuit shown in FIG. 5, and assuming an array size substantially larger than 8 rows and 8 columns, suppose that signals H1, H3, H5, H7, V1, V3, V5, and V7 are set to digital high, and the other switch signals are set to digital low. In this case, the capacitors from switched capacitor cells (0,0), (0,1), (1,0), and (1,1) will be shorted together. These capacitors will share the same potential. If these corresponding switched capacitor cells are read out, they will all have essentially the same potential, with minor differences attributed to transistor mismatch. Similarly, the switched capacitor cells (0,2), (0,3), (1,2), and (1,3) will be shorted together, and switched capacitor cells (2,0), (2,1), (3,0), and (3,1) will be shorted together. The switched capacitors across the entire switched capacitor array 307 will be similarly shorted out into 2×2 blocks of switched capacitor cells shorted to the same potential. The effect of this shorting pattern is to merge 2×2 blocks of pixels in a process that may be referred to as “binning” Each of these 2×2 blocks may be referred to as a “super pixel”. This is the electronic equivalent of downsampling the image stored on the switched capacitor array by a factor of two in each direction. It is then possible to acquire the super pixels by reading out only every other row and column from the switched capacitor array 307, for example switched capacitor cells (0,0), (0,2), (0,4), . . . , (2,0), (2,2), and so on. This requires only one fourth as many pixel acquisitions to perform, and any processor storing these pixel values needs to use only one fourth the memory.

The image stored on the switched capacitor array 307 may be binned down by other amounts. For example the signals H1, H2, H3, H5, H6, H7, V1, V2, V3, V5, V6, and V7 may be set to digital high, and the other switching signals set to digital low, to short out 4×4 blocks of switched capacitor cells, implement 4×4 size super pixels, and thereby bin and downsample the image by a factor of 4 in each direction. To read out the resulting image from the switched capacitor array, it will be necessary to read out only every fourth row and column of switched capacitor cells, for example switched capacitor cells (0,0), (0,4), (0,8), . . . , (4,0), (4,4), and so on. It is possible to bin and downsample the image by other amounts, including by a different amount in each direction: Setting signals H1 . . . H7 high, H8 low, and keeping V1 through V8 low will implement horizontal rectangular super pixels of 1×8 size. Super pixels shaped like elongated rectangles may be useful for certain image processing functions, for example the computation of one dimensional optical flow as discussed in the aforementioned U.S. Pat. No. 6,194,695.

It is also possible to use the switched capacitor array 307 to implement an approximate Gaussian smoothing function. Suppose the switched capacitor array 307 grabs an image from the focal plane 303 using the methods described above. Then consider this sequence of switching signals:

Step 1: Set H1, H3, H5, H7, V1, V3, V5, and V7 high, and others low

Step 2: Set all switching signals low

Step 3: Set H2, H4, H6, H8, V2, V4, V6, and V8 high, and others low

Step 4: Set all switching signals low

If we repeat this sequence of four steps a number of times, then the electronic effect will be that of smoothing the image stored on the switched capacitor array. The resulting image will have similarly with the original image detected by the focal plane 303, and then stored on the switched capacitor array 307, convolved with a Gaussian smoothing function. More repetition of the above four steps will result in greater smoothing.

As a more detailed example, let us discuss an exemplary algorithm that may be used to operate and read out an image from the first exemplary image sensor 301. For purposes of illustration, we will assume the image sensor has a raw resolution of 64×64 pixels, and that we are binning and downsampling it by 8 pixels in each direction. The resulting 8×8 image will be stored in the 2D matrix IM. We will also assume that we are using amplification in the row amplifier array 305. It will be understood that since the pixel circuits of FIGS. 1A and 1B output a lower voltage for brighter light, the values stored in matrix IM may similarly be lower for brighter light.

```
// Part 1: Load the switched capacitor array
set H1...H8 and V1...V8 to 00000000;
set readrow=0, selamp=1, and bypamp=0;
for row = 0...63
                set RS=row;
                set sw1=1, sw2=0, and phi=1;
                delay; // small delay to let values settle
                set phi=0;
                set sw1=0, sw2=1;
                set loadrow=1;
                delay; // small delay to allow values to settle
                set loadrow=0;
end
// Part 2: Operate switched capacitor array
set H1...H8 to 11111110;
set V1...V8 to 11111110;
set H1...H8 and V1...V8 to 00000000;
// Part 3: Read out switched capacitor array
set readrow=1;
for row = 0...7 // Loop through every eighth row
                set RS = row*8;
                delay; // insert enough delay to let analog signals settle
                for col = 0...7 // Loop through every eighth column
                  set CS = col*8;
                  delay; // insert delay to let ADC capture signal
                  IM(row,col) = digitize_pixel( ); // performed
                  using an ADC
                end
end
```

One substantial advantage of the techniques described above in association with FIGS. 3 through 6 is that an image may first be stored on the switched capacitor array 307, then binned or smoothed by operating the horizontal and vertical switching signals, and then read out at the desired resolution. The downsampling and/or smoothing is performed in analog and in parallel by the switched capacitor array 307, and it is only necessary to read out and acquire the pixels needed at the resulting resolution. This substantially speeds up the acquisition of lower resolution images from the image sensor 301.

If the first exemplary embodiment is implemented in an integrated circuit, it is advantageous to cover up the switched capacitor array so that no light strikes it. This may reduce the amount of leakage current between the top node of capacitor C1 (e.g. 533) of each switched capacitor cell and the substrate, and allow an image to be stored for more time.

It will be understood that other variations of the exemplary image sensor 301 are possible. For example, the focal plane 303, the row amplifier array 305, and the switched capacitor array 307 may each be varied. The row amplifier array may in fact be optionally eliminated if unamplified pixel signals are tolerable. Likewise the capacitors in the switched capacitor array 307 may be connected in other manners than as described, for example by utilizing additional switches to connect diagonally adjacent or other switched capacitor cells.

Second Exemplary Image Sensor

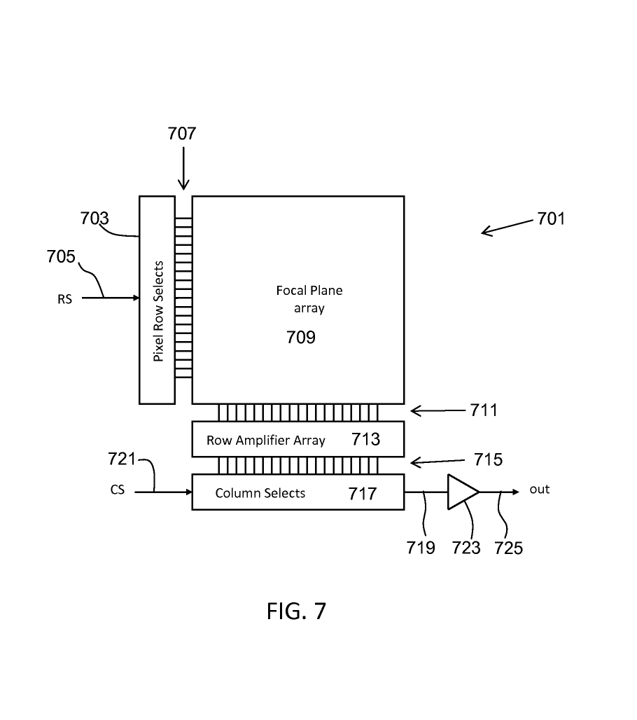

Refer to FIG. 7, which depicts a second exemplary image sensor 701 with shorting transistors in the focal plane array. In this exemplary image sensor 701, a pixel row select circuit 703 receives multibit row select signal RS 705 as an input and outputs an array of row select signals 707 to a focal plane array 709. The focal plane array 709 will be discussed below. The focal plane array 709 generates an array of column signals 711, which are output to an array of row amplifiers 713. The array of row amplifiers 713 generates an array of amplified column signals 715, which are output to a column select circuit 717. The column select circuit 717 chooses one of the amplified column signals 715 as an output 719, based on multibit column select signal CS 721. The selected amplified column signal is sent to a buffer amplifier 723 and then provided as the output 725 of image sensor 701. In the second exemplary image sensor 701, the pixel row select circuit 703, the array of row amplifiers 713, the column select circuit 717, and the output amplifier 723 may be constructed in the same manner as amplifier 316 in the first exemplary embodiment 301 described above. We now turn to the construction of the focal plane array 709.

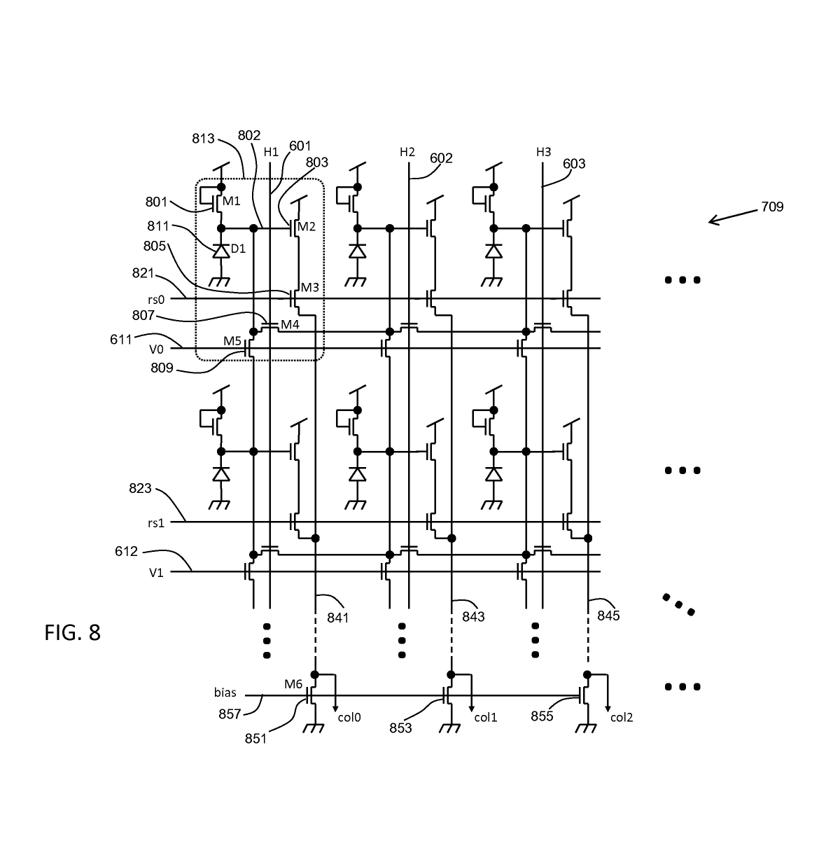

Refer to FIG. 8, which depicts the circuitry in the focal plane array 709 of the second exemplary image sensor 701. Transistors M1 801, M2 803, M3 805, M4 807, M5 809, and diode D1 811 form a single pixel circuit 813. This pixel circuit 813 may be replicated across the entire focal plane array 709. Although only the first two rows and first three columns of pixel circuits are shown, a larger array may be constructed by adding additional columns and rows of pixel circuits. M1 801 and D1 811 form the pixel circuit 101 described in FIG. 1A. (Alternatively the two-transistor pixel circuit 121 of FIG. 1B or another pixel circuit may be used.) Transistors M2 803 and M3 805 are used to read out the pixel signal at node 802 when signal “rs0” 821 is a digital high, in much the same manner as the circuit shown in FIG. 2B. However each pixel circuit of the focal plane 709 additionally contains shorting transistors M4 (e.g. 807) and M5 (e.g. 809). Note that M4 807 shorts out a pixel circuit with the pixel circuit adjacent to the right, while M5 809 shorts out a pixel circuit with the pixel circuit adjacent below. Transistors M4 807 and M5 809 behave similarly to transistors M4 539 and M5 541 of FIG. 5, except that pixel circuits are shorted together rather than capacitors. Transistors M4 807 and M5 809 may be referred to respectively as “horizontal shorting transistors” and “vertically shorting transistors”. For larger array sizes, horizontal switching signals H1 601 through H8 (e.g. 608) and vertical switching signals V1 611 through V8 (e.g. 618) may be defined and applied to the focal plane 709 in a repeating pattern in the same manner as shown in FIG. 6.

Using the horizontal and vertical shorting transistors, it is possible to short together blocks of pixel circuits into super pixels. For example, if H1, H3, H5, H7, V1, V3, V5, and V7 are high, while the other switching signals are low, the focal plane array will be configured to form 2×2 super pixels from the individual pixel circuits. In a manner similar to that of the first exemplary image sensor 301, only every other row and column of pixel circuits needs to be read out and acquired. In the same manner as the first exemplary image sensor 301, this would require acquiring fewer pixel signals and require less memory. Other sizes and dimensions of super pixels may similarly be defined. Once an image has been read out with one set of switching signals, the switching signals may be changed and after a short delay (to let the pixel circuits settle to the new connections) a new image may be read out.

As a more detailed example, let us discuss an exemplary algorithm that may be used to operate and read out an image from the second exemplary image sensor 701. For purposes of illustration, we will assume the image sensor has a raw resolution of 64×64 pixels, and that we are downsampling it by 8 pixels in each direction. The resulting 8×8 image will be stored in the two dimensional matrix IM. We will also assume that we are using amplification in the row amplifier array 713. It will be understood that since the pixel circuits formed by transistors M1 (e.g. 801) and D1 (e.g. 811) output a lower voltage for brighter light, the values stored in matrix IM may similarly be lower for brighter light.

// Part 1: Initialization
set selamp=1 and bypamp=0;
// Part 2: Configure switching signals
set H1...H8 to 11111110;
set V1...V8 to 11111110;
delay; // delay to let focal plane settle
// Part 3: Read out focal plane

| | |
|---|---|
| for row = 0...7 | // Loop through every eighth row |
| | set RS = row*8; |
| | set sw1=1, sw2=0, and phi=1; |
| | delay; // small delay to let row amplifiers settle |
| | set phi=0; |
| | set sw1=0, sw2=1; |
| | delay; // insert enough delay to let analog signals settle |
| | for col = 0...7 // Loop through every eighth column |
| | set CS = col*8; |
| | delay; // insert delay to let ADC capture signal |
| | IM(row,col) = digitize_pixel( ); // performed |
| | using an ADC |
| | end |
| end | |

Third Exemplary Image Sensor

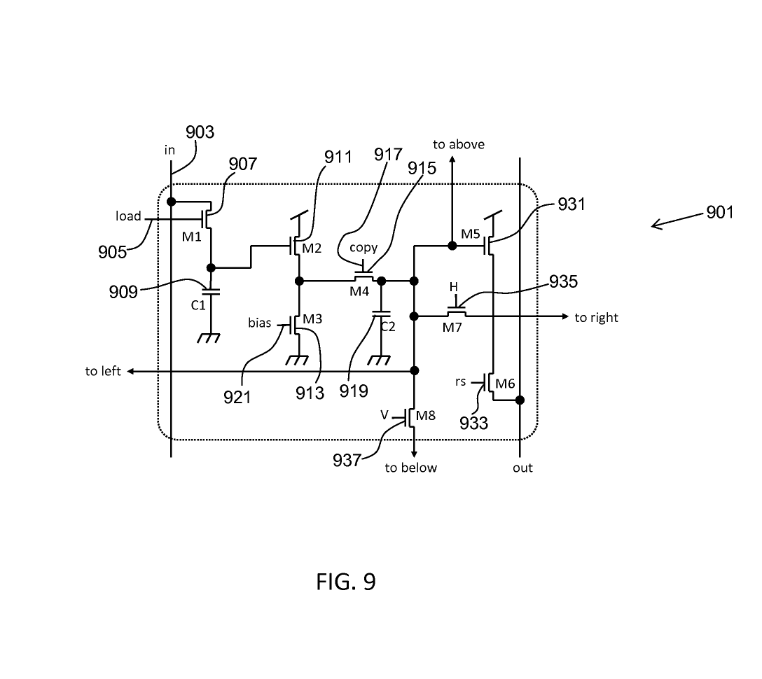

Another variation of the first exemplary image sensor 301 will now be discussed. The third exemplary embodiment may be constructed exactly the same as the first exemplary image sensor 301. The one difference is in the construction of the switched capacitor cells (e.g. 543) of the switched capacitor array 307. Refer to FIG. 9, which depicts a two capacitor switched capacitor cell 901. The third exemplary embodiment may be constructed by taking each switched capacitor cell (e.g. 543) of FIG. 5, e.g. transistors M1 531 through M5 541 and capacitor C1 533, and replacing them with the circuit 901 depicted in FIG. 9.

The input signal “in” 903, the load signal “load” 905, transistor M1 907, and capacitor C1 909 behave substantially the same as the corresponding input signal (e.g. 521), load signal (e.g. 511), transistor M1 (e.g. 531), and capacitor C1 (e.g. 533) of a switched capacitor cell (e.g. 543) of FIG. 5. When the “load” 905 signal is pulsed high, capacitor C1 909 samples the potential at “in” 903.

Transistors M2 911 and M3 913 form a source follower circuit that buffers the voltage on capacitor C1 909. Transistor M4 915 is connected to a global signal “copy” 917 that, when pulsed high, deposits a potential on capacitor C2 919 that is a buffered version of the potential on capacitor C1 909. Note that it is beneficial for the bias voltage 921 at the gate of transistor M3 913 to be set to place transistor M3 913 in the “subthreshold region” to limit the current consumption of this circuit. To further reduce current consumption, it is possible to set the bias voltage 921 to zero except for when the potential across capacitor C1 909 is being copied to capacitor C2 919. It will be understood that the “copy” signal 917 and the bias voltage 921 may be global signals shared by all instances of the switched capacitor cell 901 using in the third exemplary embodiment.

A switched capacitor array constructed from switched capacitor cells (e.g. 901) as shown in FIG. 9 may be loaded with an image from the focal plane 303, one row at a time, and in the same manner as described above. This would cause the C1 capacitors (e.g. 909) to store an image based on the light pattern striking the focal plane 303. When the “copy” 917 signal is pulsed high, the C2 capacitors (e.g. 919) would then store the same image, minus any voltage drop attributable to transistor M2 (e.g. 911).

Transistors M5 931, M6 933, M7 935, and M8 937 behave substantially and respectively the same as transistors M2 535, M3 537, M4 539, and M5 541 of FIG. 5. Transistor M5 931 is used to read out the potential across capacitor C2 919, transistor M7 935 is a horizontal switching transistor that connects C2 919 to the capacitor C2 of the switched capacitor circuit adjacent on the right, and transistor M8 937 is a vertical switching transistor that connects to capacitor C2 of the switched capacitor circuit adjacent below. Transistors M7 935 and M8 937 may be connected respectively to a horizontal switching signal and a vertical switching signal in the same manner depicted in FIGS. 5 and 6. The difference is that they may bin or smooth the image stored on the C2 capacitors (e.g. 919). Switching signals H1 601 through H8 608 and V1 611 through V8 618 may be defined and applied to the respective transistors M7 (e.g. 935) and M8 (937) of each switched capacitor cell. An advantage of the circuitry used in the third exemplary image sensor is that once an image has been binned, downsampled, and/or smoothed and read out, the C2 capacitors can be refreshed with the original image stored on the C1 capacitors by again pulsing high the “copy” signal.

The algorithm for operating and reading out the third exemplary image sensor is essentially the same as that for reading out the first exemplary image sensor 301, except that after the switched capacitor array 307 is loaded and before the switching signals are operated, the “copy” signal 917 needs to be pulsed high.

If the third exemplary embodiment is implemented in an integrated circuit, it is advantageous to cover up the switched capacitor array 307 so that no light strikes it. This may reduce the amount of leakage current between the top node of capacitor C1 909 and the substrate, and between the top node of capacitor C2 919 and the substrate, and allow an image to be stored for more time.

Comparison of the Above Exemplary Image Sensors

The above three exemplary image sensors are similar in that they allow a raw image as captured by their respective pixel arrays to be read out at raw resolution or read out at a lower resolution. The binning function implemented by the switching or shorting transistors is capable of merging together blocks of pixels or sampled pixel values into super pixels. The readout circuits then allow the reading out of only one pixel value from each super pixel, thus reducing the number of pixels acquired and memory required for storing the image data. However there are differences between the three exemplary image sensors that may make one image sensor more appropriate for a given application than another.

The second exemplary image sensor 701 is the simplest circuit, since the pixel shorting transistors are located within the focal plane 709. For a given resolution, fewer transistors and capacitors need to be utilized to implement the second exemplary image sensor 701. In addition, the second exemplary image sensor 701 is potentially faster than the other two exemplary image sensors. This is because once the switching signals H1 through H8 and V1 through V8 are set, and the pixel circuits settle to the new resulting values, the desired pixel signals may then be read out. There is no need to first load a switched capacitor array with pixel signals prior to binning/smoothing and readout. However the second exemplary image sensor 701 as depicted above is unable to implement Gaussian type smoothing functions by switching multiple times (e.g. turn on first odd-valued switching signals and then even-valued, and repeating this process several times). The second exemplary image sensor circuit generally only constructs rectangular super pixels, when implemented in the manner shown above in FIGS. 7 and 8.

The first exemplary image sensor 301 is more flexible than the second exemplary image sensor 701 in that smoothing may be implemented by cycling through different patterns of the switching signals. Gaussian smoothing functions may be approximated. However the first exemplary image sensor 301 requires more components per pixel to implement than the second 701, and may be slower since the switched capacitor array 307 needs to be loaded with an image from the focal plane 303 prior to any binning, smoothing, or downsampling. (There is an exception—it is possible to sample an image, perform some binning and/or smoothing, read out the image from the switched capacitor array 307, perform more binning and smoothing, and then read out the resulting image from the switched capacitor array 307.)

The third exemplary image sensor is similar to the first exemplary image sensor 301 but has one advantage—Once an image is sampled onto the C1 capacitors (e.g. 909) of the switched capacitor array, this image may then be quickly loaded with the “copy” signal 917 onto the C2 capacitors (e.g. 919) for smoothing and/or binning Once the raw image is processed with the C2 capacitors and switching transistors (e.g. 935 and 937) and then read out, the raw image may be quickly restored with the same “copy” signal 917. This allows essentially the same raw image to be processed in different ways without having to reload the switched capacitor from the focal plane every time. Multiple binned/smoothed images may thus be generated from the same original snapshot of pixel signals. In contrast, with the first exemplary image sensor 301, once the raw image has been binned or smoothed, it may be necessary to reload the switched capacitor array, after which time the visual scene may have changed. However the third exemplary image sensor has the disadvantage of requiring more transistors and capacitors per pixel to implement. Furthermore transistors M2 (e.g. 911) and M5 (e.g. 931) each contribute a voltage drop that may limit the available voltage swing to encode image intensities.

Other Variations

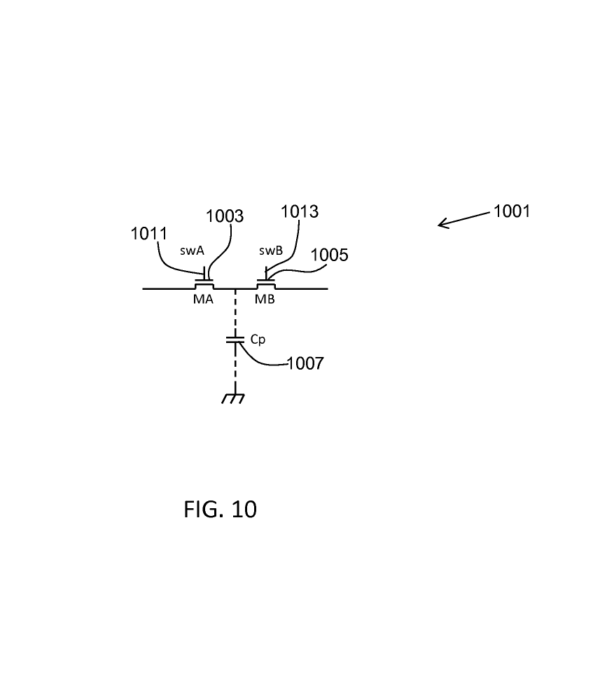

Let us now discuss a variation that may be made to the first and third exemplary image sensors described above. Note that in both of these exemplary image sensors, a single switching transistor connects two capacitors from two adjacent switched capacitor cells. Specifically these are M4 539 and M5 541 of each switched capacitor cell (e.g. 543) of FIG. 5 and M7 935 and M8 937 of each switched capacitor cell 901 as depicted in FIG. 9. An alternative is to replace each of these transistors with two transistors in series, for example the two transistor switching circuit 1001 shown in FIG. 10. Two transistors MA 1003 and MB 1005 are in series, and would replace one of the aforementioned switching transistors. A small amount of parasitic capacitance Cp 1007 may exist between the node shared by the two transistors 1003 and 1005 and ground, or such a capacitor may be placed in deliberately. These two transistors would be operated by two switching signals “swA” 1011 and “swB” 1013 which replace the original one switching signal. For example transistor M4 539 of the top left switching capacitor cell 543 of FIG. 5 may be replaced with two transistors M4A and M4B and switching signal H1 601 may be replaced with switching signals H1A and H1B.

When both switching signals “swA” 1011 and “swB” 1013 are digital high, both transistors 1003 and 1005 are on and the two connected nodes are shorted together. Alternatively the following sequence may be used and repeated a number of times:

Step 1: swA=high, swB=low

Step 2: swA=low, swB=low

Step 3: swA=low, swB=high

Step 4: swA=low, swB=low

If this sequence is repeated several times, then the charges of the two respective capacitors connected by these transistors is not equalized (in potential) but redistributed slightly, by an amount determined by Cp 1007 and the appropriate capacitor in the switched capacitor cell. For example, suppose a left capacitor and a right capacitor were connected by the circuit 1001 shown in FIG. 10, and the left capacitor had a higher potential than the right capacitor. If the above four steps are repeated several times, some of the charge from the left capacitor will be redistributed to the right capacitor so that their respective potentials are closer. This arrangement can be used to implement a weaker smoothing than that possible by simply shorting together the two switched capacitor cells. It will be understood that to use this variation, each of the sixteen switching signals H1 . . . H8 and V1 . . . V8 would be replaced with two switching signals, to form a total of thirty two switching signals H1A, H1B, . . . , HBA, H8B, VIA, V1B, . . . , VBA, V8B.

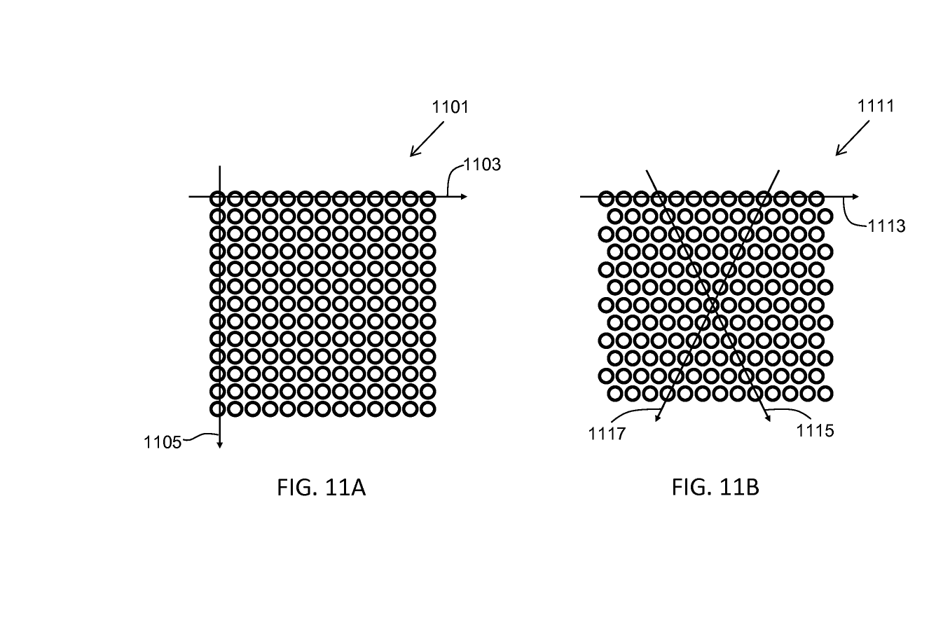

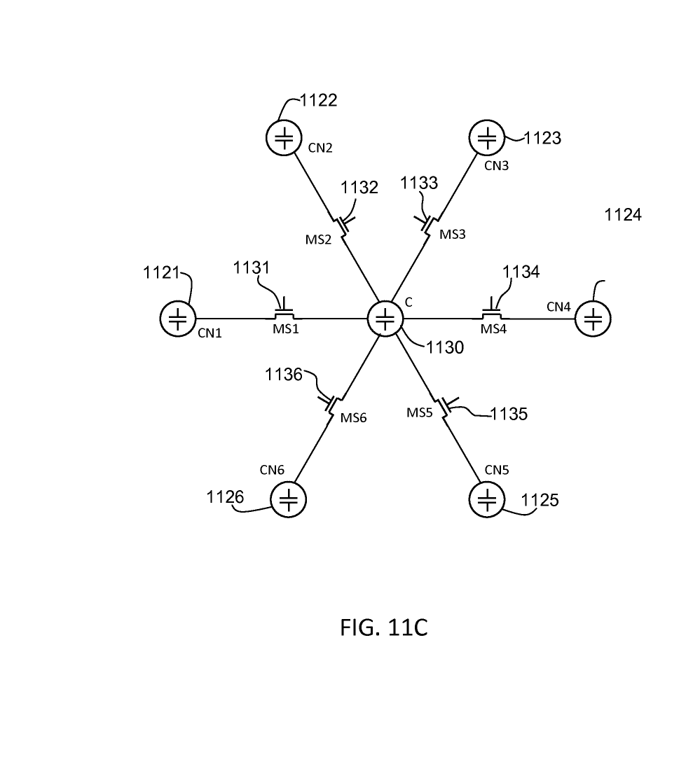

Another variation that may be made to the first and third exemplary image sensors, including the aforementioned variations incorporating the technique depicted in FIG. 10, is to use a hexagonal pixel arrangement rather than a square or rectangular one. FIG. 11A depicts a rectangular arrangement of pixels 1101 and FIG. 11B depicts a hexagonal arrangement of pixels 1111. Note that a rectangular arrangement 1101 has two axes 1103 and 1105 that are 90 degrees apart while a hexagonal arrangement 1111 has three axes 1113, 1115, and 1117 that are 60 degrees apart. Similarly, in a rectangular arrangement 1101 every pixel has four adjacent pixels (ignoring diagonally adjacent pixels) while in a hexagonal arrangement 1111 every pixel has six adjacent pixels. In order to apply a hexagonal arrangement to the first and third exemplary embodiments, one would apply the hexagonal arrangement 1111 to both the focal plane 303 and the switched capacitor array 307. The pixel array may be accordingly modified by changing the aspect ratio of each pixel circuit from a 1:1 square to a 2:\sqrt{3} aspect ratio (wider than tall) and then shift every other row by a half pixel to the right. The switched capacitor array 307 may similarly be modified by shifting every other row of switched capacitor cells by one half a cell to the right, and then for each switch capacitor cell, replace the two switching transistors (originally connecting to the right and down) with three switching transistors, one connecting to the right, one connecting down-right by 60 degrees, and one connecting down-left by 60 degrees. FIG. 11C shows how each switched capacitor cell would be connected to its six neighbors in a hexagonal arrangement: Capacitor C 1130 represents the capacitor used for smoothing (C1 533 of FIG. 5 and C2 919 of FIG. 9). Capacitor C 1130 may be connected to its six neighboring counterparts CN1 1121 through CN6 1126 using six switching transistors MS1 1131 through MS6 1136. The number of switching signals would need to be increased to handle the third direction. For example, the sixteen switching signals H1 . . . H8 and V1 . . . V8 may be replaced with the twenty four switching signals A1 . . . A8, B1 . . . B8, and C1 . . . C8. Each of the three sets of switching signals A1 . . . A8, B1 . . . B8, and C1 . . . C8 would therefore be oriented parallel to the three main axes 1113, 1115, and 1117 of the array.

One characteristic of many image sensors incorporating logarithmic pixel circuits is that they may have a significant amount of fixed pattern noise (FPN). Such FPN originates from mismatch between transistors or other components from one instance of a circuit to another. Sample transistors that may contribute to FPN include any transistors in the pixel circuits 101 or 121, row readout transistors such M2 239 and M4 245 in FIG. 2B, transistors M3 421 or M4 403 in FIG. 4, capacitor readout transistors M2 535 and M6 561 of FIG. 307, and transistors M1 907, M2 911, M3 913, and M5 931 of FIG. 9. This FPN may manifest itself as a fixed random image that is added to the “ideal” image acquired by the image sensor. The aforementioned book edited by Yadid-Pecht and Etienne-Cummings describes fixed pattern noise and some techniques for eliminating or reducing it. FPN may be removed or reduced in software using the following method: First expose the image sensor to a uniform environment. This may be performed by uncovering the image sensor and exposing it directly to ambient light, without optics, so that every pixel circuit is illuminated substantially equally. Less preferably, this may be performed by placing a uniform pattern, such as a blank sheet of paper, right in front of the lens covering the image sensor. Then read out and acquire an image from the image sensor. The resulting image may be used as a “fixed pattern noise calibration mask” that may be stored for later use. Later on, when the image sensor is in use, the fixed pattern noise calibration mask may be subtracted from the raw pixels read off the image sensor to create an image with eliminated or substantially reduced fixed pattern noise.

It will be understood that each image sensor, even if fabricated from the exact same layout or design, has its own fixed pattern noise. Likewise if any of the above three exemplary image sensors is operated with a different switching signal configuration for forming super pixels or for implementing smoothing, each such configuration will also have its own associated fixed pattern noise mask. Even changing parameters such as whether or not to use the amplification provided by the row amplifier array 305 may affect the fixed pattern noise. Thus it may be necessary to record and store a separate fixed pattern noise calibration mask for every permutation of specific image sensor, switching signal configuration, and amplifier setting to be used.

Exemplary Method of Computing Optical Flow

We now discuss an algorithm that may be used to compute optical flow from a camera system incorporating any of the image sensors above. As described above, logarithmic response pixels have a fixed pattern noise that can vary with temperature. Therefore it is desirable to have a way to compute optical flow in a manner that does not require a precomputed fixed pattern noise mask. We next discuss one such algorithm. For this discussion, we will use the prior art image sensor 201 described in FIGS. 2A and 2B. It will be understood that any of the three exemplary image sensors discussed above may be used, and the algorithm may be performed on the acquired super pixel signals as well as the raw pixels. We will assume that a lens is arranged to focus light from a visual scene onto the image sensor as shown in FIG. 2C above. We will also assume the image sensor is connected to a processor with an analog digital converter (ADC), and configured so that the processor may acquire an image from the image sensor and store it in memory. An ADC typically has a certain “bit depth” and an associated number of “quantum levels”, with the number of quantum levels equal to the number two raised to the bit depth. For example, a 12-bit ADC may have 4096 quantum levels. We may use the term “quantum level” to refer to the amount of change in an analog signal required for the ADC's output to increase by one integer value. We will assume that the resolution of the image acquired and deposited into the processor's memory has “m” rows and “n” columns, e.g. forms an m×n image.

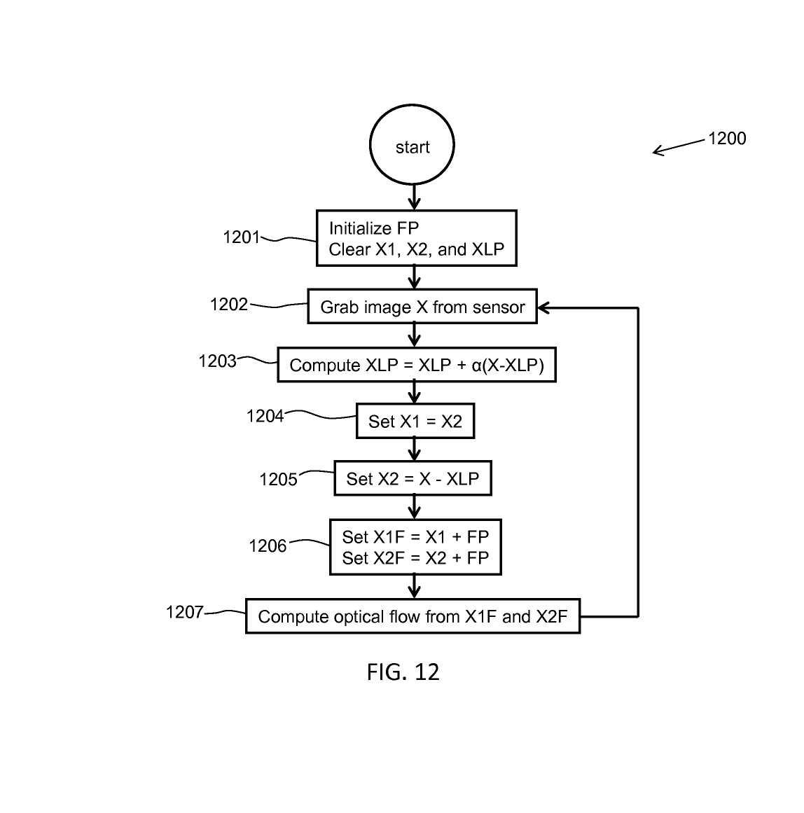

Refer to FIG. 12, which depicts an exemplary algorithm for computing optical flow 1200. This algorithm comprises seven steps, which will be described below using MATLAB code:

Step 1 (1201): “Initialize FP and clear X1, X2, and XLP”. This may be performed using the following MATLAB instructions. Note that variable “fpstrength” indicates the strength of a fixed pattern noise mask and is a parameter that may be adjusted for a particular application. It is advantageous for fpstrength to be substantially less than the typical range of values observable in the visual field, but greater than or equal to the typical frame to frame noise in the sensor system. For example, suppose the typical noise level within a pixel is on the order of two ADC quantum levels (as determined by the precision of the analog to digital converter used to acquire the pixel values), and the typical variation of the texture from darker regions to brighter regions is on the order of 50 quantum levels. A suitable value for fpstrength may be on the order of two to ten.

fpstrength=1.0;
FP=fpstrength*rand(m,n);
X1=zeros (m,n);
X2=zeros (m,n);
XLP=zeros (m,n);
The matrix FPN may alternatively be formed using tilings of the array [0 0 0 0; 0 1 1 0; 0 1 1 0; 0 0 0 0] multiplied by fpstrength. For example, for an 8×8 array the matrix FPN may be generated as follows:

$$FP = [ \begin{matrix}0 & 0 & 0 & 0 & 0 & 0 & 0 & 0 \\ 0 & 1 & 1 & 0 & 0 & 1 & 1 & 0 \\ 0 & 1 & 1 & 0 & 0 & 1 & 1 & 0 \\ 0 & 0 & 0 & 0 & 0 & 0 & 0 & 0 \\ 0 & 0 & 0 & 0 & 0 & 0 & 0 & 0 \\ 0 & 1 & 1 & 0 & 0 & 1 & 1 & 0 \\ 0 & 1 & 1 & 0 & 0 & 1 & 1 & 0 \\ 0 & 0 & 0 & 0 & 0 & 0 & 0 & 0\end{matrix} ] ;$$

$$FP = FP * fpstrength ;$$

Step 2 (1202): “Grab image X from sensor”. In this step, the processor 297 grabs an m×n image from the image sensor 283 and deposits it into m×n matrix X. Image X may be a raw image or may be an image of super pixels. This step may be performed as described above for the above exemplary image sensors or prior art image sensor. It will be understood that the acquisition of X from the image sensor accounts for the aforementioned image inversion performed by any optical assembly when an image is focused onto a focal plane.

Step 3 (1203): “Compute XLP=XLP+alpha(X-XLP)”. This may be performed using the following MATLAB instructions. XLP will be a time-domain low-passed version of X. Note that variable “alpha” is between zero and one and controls the low pass filter cutoff frequency. This parameter may be adjusted for a particular application.

alpha=0.1; % set to a value between 0 and 1
XLP=XLP+alpha*(X-XLP);

Step 4 (1204): “Set X1=X2”. This may be performed with the following MATLAB instruction:

### X1=X2;

Step 5 (1205): “Set X2=X−XLP”. X2 will be a time domain high-passed version of X. In other words, each element of X2 will be a time domain high-passed version of the corresponding element of X. This may be performed with the following MATLAB instruction:

### X2=X−XLP;

Step 6 (1206): “Set X1F=X1+FP and X2F=X2+FP”. This may be performed with the following MATLAB instructions:

### X1F=X1+FP;

### X2F=X2+FP;

Step 7 (1207): “Compute optical flow from X1F and X2F”. Using X1F and X2F respectively as a first and second image, compute the optical flow between the two images. The result becomes the output optical flow of the algorithm. After completing this step the algorithm returns to Step 2 (1202). Steps 2 (1202) through Steps 7 (1207) therefore represent one cycle of the algorithm 1200. The computation of optical flow may be performed with a wide variety of algorithms. One possible method of computing optical flow may be performed using the following MATLAB instructions:

delta=1;
[ofx,ofy]=ii2(X1F,X2F,delta);
using the following MATLAB function “ii2”. This function is an implementation of Srinivasan's “Image Interpolation Algorithm (IIA)” which is disclosed in the aforementioned publication “An image-interpolation technique for the computation of optical flow and egomotion” by Srinivasan.

% ===================================================
function [ofx,ofy] = ii2(X1,X2,delta)
% function [ofx,ofy] = ii2(X1,X2,delta)
% computes optical flow using 2D variant of Srini's image
% interpolation algorithm
%
% X1, X2 = first and second image frame
% delta = delta shift for computation
% ofx,ofy = returned optical flow in pixels
%
[fm,fn] = size(X1);
ndxm = 1+delta:fm−delta;
ndxn = 1+delta:fn−delta;
f0 = X1(ndxm,ndxn);
fz = X2(ndxm,ndxn);
f1 = X1(ndxm,ndxn+delta);
f2 = X1(ndxm,ndxn−delta);
f3 = X1(ndxm+delta,ndxn);
f4 = X1(ndxm−delta,ndxn);
A = sum(sum( (f2−f1).\hat{ }2 ));
B = sum(sum( (f4−f3).*(f2−f1) ));
C = 2*sum(sum( (fz−f0).*(f2−f1) ));
D = sum(sum( (f2−f1).*(f4−f3) ));
E = sum(sum( (f4−f3).\hat{ }2 ));
F = 2*sum(sum( (fz−f0).*(f4−f3) ));
mat = [A B; D E];
invmat = inv(mat);
xyhat = invmat * [C;F];
ofx = delta*xyhat(1);
ofy = delta*xyhat(2);
% ===================================================

It will be understood that other optical flow algorithms may be used, including but not limited to variations of the aforementioned algorithm by Lucas and Kanade. The MATLAB function LK2 below shows an implementation of the Lucas and Kanade optical flow algorithm in two dimensions:

% ===================================================
function [ofx, ofy] = LK2(X1, X2)
% X1 and X2 are two sequential 2D images
% ofx and ofy are X and Y optical flows
SearchImg = X1;
CurImg = X2;
% determine dimensions and setup
[InHeight, InWidth] = size(CurImg);
Inset = 1;

| | |
|---|---|
| RegHeight = InHeight − Inset*2; | RegWidth = InWidth − Inset*2; |
| dIx = zeros(RegHeight, RegWidth); | dIy = zeros(RegHeight, |
| | RegWidth); |
| dIt = zeros(RegHeight, RegWidth); | |

% compute spatial derivatives
for r = 1 : RegHeight
for c = 1 : RegWidth

| | |
|---|---|
| dIx(r, c) = | (CurImg(r+Inset, c+Inset+1) − CurImg(r+Inset, |
| | c+Inset−1)) / 2; |
| dIy(r, c) = | (CurImg(r+Inset+1, c+Inset) − CurImg(r+Inset−1, |
| | c+Inset)) / 2; |

```
    end
end
% compute temporal derivative
for r = 1 : RegHeight
    for c = 1 : RegWidth
```

| | |
|---|---|
| dIt(r, c) = | double(CurImg(r+Inset, c+Inset) − |
| | SearchImg(r+Inset, c+Inset)); |

end
end
% compute combination arrays used in computation

| | |
|---|---|
| dIxSq = dIx .* dIx; | dIySq = dIy .* dIy; |
| dIxdIy = dIx .* dIy; | |
| dIxdIt = dIx .* dIt; | dIydIt = dIy .* dIt; |
| % clear sums | |
| dIxSqSum = 0; | dIySqSum = 0; |
| dIxdIySum = 0; | |
| dIxdItSum = 0; | dIydItSum = 0; |

```
% process window
for r = 1 : RegHeight
    for c = 1 : RegWidth
        % compute sums
        dIxSqSum = dIxSqSum + dIxSq(r, c);
        dIySqSum = dIySqSum + dIySq(r, c);
        dIxdIySum = dIxdIySum + dIxdIy(r, c);
        dIxdItSum = dIxdItSum + dIxdIt(r, c);
        dIydItSum = dIydItSum + dIydIt(r, c);
    end
end
% store “A” matrix for computation and check for non-singular matrix
AMat = [dIxSqSum, dIxdIySum; dIxdIySum, dIySqSum];
Det = dIxSqSum*dIySqSum − dIxdIySum*dIxdIySum;
% check if determinant valid
if (Det ~= 0)
    % compute pixel shift result (stored [ShiftX, ShiftY])
    MatResult = (AMat\hat{ }−1) * [−dIxdItSum; −dIydItSum];
    ofx = MatResult(1); ofy = MatResult(2);
% matrix is singular
else
    % zero out result
```

| | |
|---|---|
| ofx = 0; | ofy = 0; |

end
% ===================================================

The above algorithm 1200 functions as follows: At the end of Step 5 (1205), the matrices X1 and X2 will contain two time domain high-passed images based on two sequential frames of X acquired from the image sensor. Note that it will take several cycles of the algorithm to occur before a good optical flow measurement is obtained. This is because it will take at least several cycles for X1 and X2 to represent valid sequential frames, and also because it will take time for the matrix XLP to adapt towards the input environment and the fixed pattern noise in the image sensor. Since the matrices X1 and X2 are time domain high-passed versions of sequential values of X, and since fixed pattern noise is essentially constant (e.g. a “DC term”), the fixed pattern noise is filtered out and thus substantially removed in X1 and X2.

However note that in algorithm 1200 we do not compute optical flow directly from X1 and X2. This is because if the actual visual motion stops, then X will be substantially constant. Then XLP will adapt to become equal to the input image X. This will cause X1 and X2 to be matrices with values near zero. Electrical noise in the image sensor or the entire system may dominate the values X1 and X2, and may cause erroneous large optical flow measurements. We mitigate this problem by adding back a small but controlled fixed pattern FP to X1 and X2, to generate X1F and X2F, and compute optical flow on these latter values. Thus when the scene is unchanging, X1F and X2F will be dominated by the same pattern FP, and thus the computed optical flow will be near zero. The use of FP in this manner may be considered a practical modification to limit the computed optical flow when the actual visual motion stops.

Note that the value “delta=1” is appropriate for when the optical flow is generally less than one pixel per frame. For larger optical flow, a larger value of “delta” may be appropriate. In this case, it may be beneficial to smooth images X1F and X2F (either in hardware using the techniques above or in software) before calling the function “ii2”. Also note that the parameter “alpha” adjusts the cutoff frequency of the high pass filter being applied to pixel values, with a higher value of “alpha” corresponding to a higher cutoff frequency. Thus if “alpha” is set too high for a particular environment, the algorithm may have trouble sensing motion. Finally note that other optical flow algorithms than that depicted in the above MATLAB function “ii2” may be used.

If we know for a fact that the above algorithm will be used in an application in which the sensor will always be in motion, it may be possible to remove Step 1206 and compute optical flow directly from X1 and X2.

Note that a system incorporating any image sensor, in particular the prior art image sensor of FIGS. 2A and 2B or any of the above exemplary image sensors, optics configured to place light from the environment onto the image sensor, a processor configured to acquire an image from the image sensor, and running an algorithm (such as that of FIG. 12) that generates optical flow measurements based on the image data from the image sensor, may be referred to as an “optical flow sensor”. This includes the system 281 as depicted in FIG. 2C when the processor 297 is configured to measure optical flow from the image acquired from the image sensor 283.

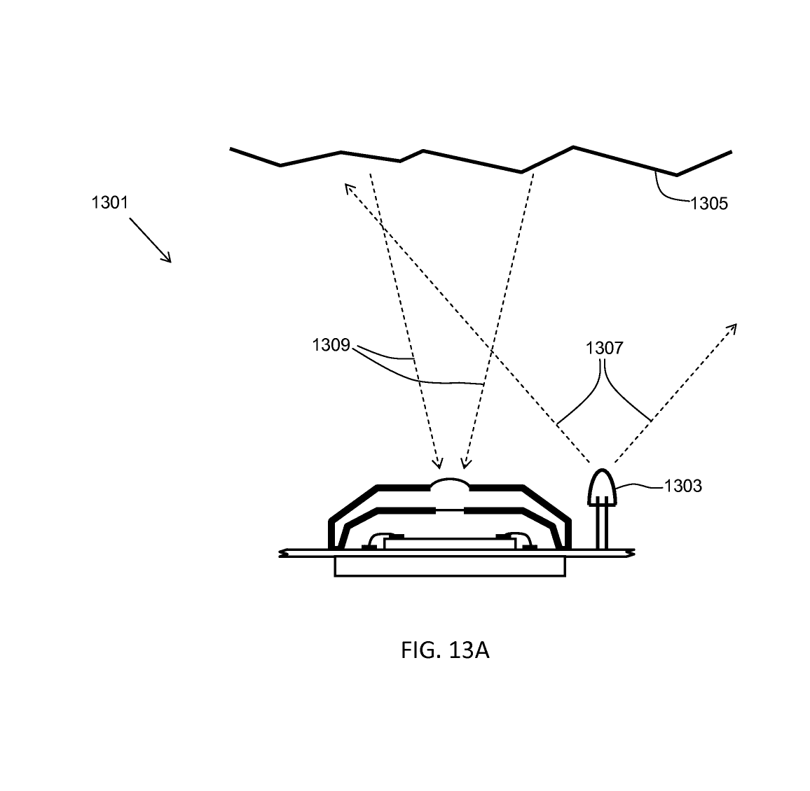

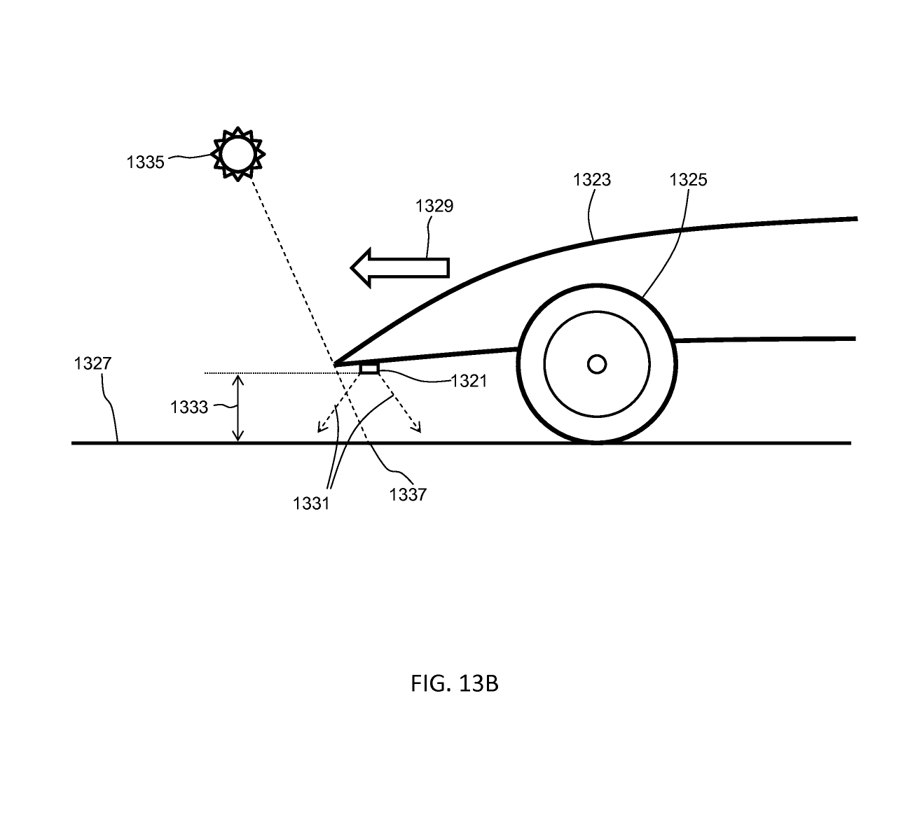

Refer to FIG. 13A, which shows a vision sensor 1301 with an LED 1303. Vision sensor 1301 may be constructed similarly to the camera 281 of FIG. 2C. An LED 1303 illuminates the environment 1305, with the majority of illumination in a light cone 1307. One benefit of the above algorithm 1200 is that when used with logarithmic response pixels it is particularly useful when operated with LED illumination. Suppose the algorithm 1200 is used in a dark environment, and LED 1303 or another light emitting source is located close to the vision sensor 1301 and oriented to illuminate the environment 1305 that the vision sensor 1301 can sense. It is beneficial that the vision sensor's field of view 1309 images portions of the environment 1305 that are within the LED's light cone 1307. If the LED 1303 is bright enough, it will illuminate the environment 1305 adequately so that the image sensor may sense it and so that the above algorithm 1200 may compute optical flow. However the LED 1303 may have a non-uniform pattern, including within its light cone 1307, and thus illuminate the environment unevenly. The LED illumination pattern will be multiplicative in nature. Let L(m,n) equal the relative illumination provided by the LED 1303 in different directions, as sensed by the vision sensor 1301 at pixel (m,n). This is equivalently the image received by the vision sensor 1301 when it and the LED 1303 are placed at the center of a uniform white sphere with a lambertian surface. Let E(m,n) be the ideal image intensities focused on the image sensor if the LED 1303 were ideal and illuminated all directions equally. E may be due to the surface reflectances of different objects in the environment. The amount of light that will strike the image sensor of the vision sensor 1301 will be roughly

W(m,n)=(m,n)×E(m,n),

where matrices L and E are element-wise multiplied. However when the light pattern W is presented to an image sensor with logarithmic response pixels, the acquired image X will be based on the logarithm of W, in the following equation (using element-wise matrix arithmetic):

$$\begin{matrix}X ( m , n ) = log ( W ( m , n ) ) \\ = log ( L ( m , n ) \times E ( m , n ) ) \\ = log ( L ( m , n ) ) + log ( E ( m , n ) )\end{matrix}$$

It will be understood that the value log(E) is a DC term. Hence it is, from the perspective of the above algorithm, mathematically similar to any fixed pattern noise already inherent in the image sensor. Thus the above algorithm 1200 of FIG. 12 will be able to filter out log(E), and therefore filter out the effects of uneven illumination provided by the LED 1303.

Let us discuss another application of an optical flow sensor implemented using algorithm 1200. Refer to FIG. 13B, which depicts an optical flow sensor 1321 mounted on a car 1323 in front of the car's wheel 1325. The optical flow sensor 1321 may be mounted on the underside of the car 1323 as shown in the Figure, so that the optical flow sensor 1321 may view the road 1327. Suppose the car 1323 is traveling to the left at a velocity 1329 as shown. The texture on the road 1327, as seen in the field of view 1331 of the optical flow sensor 1321, will appear to move in the opposite direction e.g. to the right. The magnitude of the measured optical flow will be the velocity 1329 of the car divided by the height 1333 of the sensor 1321 above the road 1327

An optical flow sensor used in this configuration may be used to measure slip between the wheel 1325 and the road 1327. Knowledge of wheel slip or tire slip is useful since it can indicate that the car 1323 is undergoing rigorous motion or potentially spinning out of control. If the car 1323 is a high performance sports car or race car, then knowledge of wheel slip or tire slip may be used to help detect the car's physical state and assist with any vehicle stability mechanisms to help the car's driver better control the car 1323. Wheel slip may be measured as follows: First compute the two dimensional optical flow as seen by the optical flow sensor 1321 in pixels per frame. Then compute the optical flow in radians per second by multiplying the pixels per frame optical flow measurement by the frame rate of the optical flow sensor in frames per second, and multiplying the result by the pixel pitch in radians per pixel. It will be understood that the pixel pitch in radians per pixel may be obtained by dividing the pitch between pixels on the image sensor by the focal length of the vision sensor's optics. Then multiply the two dimensional optical flow measurement in radians per second by the height 1333 to obtain a two dimensional measurement of the actual ground velocity 1329. Then, measure the angular rate of the wheel 1325, and multiply the angular rate by the radius of the wheel 1325. This will produce a wheel speed measurement. Produce a wheel velocity measurement by forming a vector according to the orientation of the wheel, which may generally be perpendicular to the wheel's axle, and whose magnitude is the wheel speed measurement. Wheel slip or tire slip is then the difference between the actual ground velocity measurement and the wheel velocity measurement.

In an outdoor environment, the presence of sun 1335 may affect the accuracy of the optical flow measurement seen by the optical flow sensor 1321. This is because at certain angles, the sun 1335 may cast a shadow on the road 1327. If the border 1337 of the shadow rests partially within the field of view 1331 of the optical flow sensor 1321, the shadow may corrupt the optical flow measurement, in particular if the contrast of the shadow is stronger than any texture in the road 1327. As the car 1323 drives through a curve, the shadow's boundary 1337 itself may move, further adding erroneous components to the optical flow measurement. It is therefore desirable to remove the effects of the shadow on the optical flow measurement. One characteristic that may be exploited, however, is the fact that for many cars, driving speeds that are sufficient to cause slip between the wheel 1325 and the road 1327, the optical flow viewed by the sensor 1321 due to the road 1327 will be much faster than any optical flow due to the moving shadow edge 1337.

Suppose the optical flow sensor 1321 is implemented using the vision sensor 281 described above, using a logarithmic response image sensor and the exemplary algorithm 1200 shown in FIG. 12. Suppose the optical flow due to the road 1327 is substantially faster than the optical flow due to the movement of the shadow edge 1337. The parameter alpha as used in Step 3 (1203) of the exemplary algorithm 1200 may be set to a value that filters out the slower optical flow due to the shadow while preserving the faster optical flow due to the road 1327. The value of alpha may be found empirically for a given application by making it large enough to filter out the shadow motion, but not so large as to filter out the road motion.

Preliminary Information for Vision Based Flight Control

We will now discuss the control of an air vehicle using optical flow, which may be performed using the exemplary image sensors described above. First we provide background information that will be useful for the teachings that follow. It will be understood that an “air vehicle” may refer to any vehicle capable of flying, including but not limited to a helicopter, a fixed-wing air vehicle, a samara-type air vehicle, a helicopter with coaxial and contra-rotating rotors, and a quad-rotor helicopter, or any other type of air vehicle. The teachings below will be described in the context of a small rotary-wing air vehicle flying in air. It will also be understood that the following teachings may be applied to vehicles capable of moving through other mediums, including but not limited to underwater vehicles and space-borne vehicles.

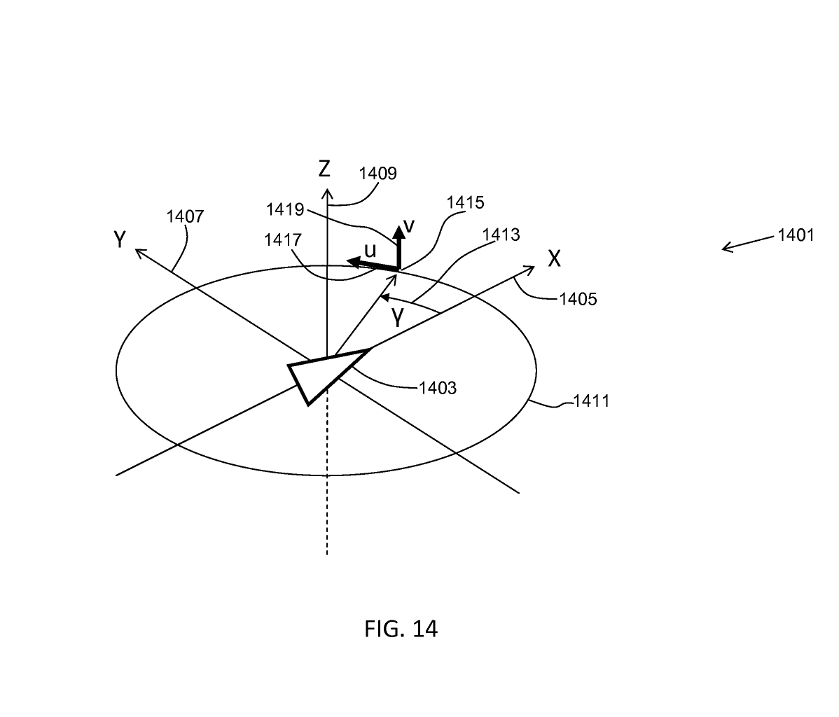

FIG. 14 shows a coordinate system 1401 that will be used in the teachings below. An air vehicle 1403 is depicted as triangle for simplicity. The X-axis 1405 points in the forward direction of the air vehicle 1403. The Y-axis 1407 points in the left-hand direction. The Z-axis 1409 points upward. A yaw circle 1411 surrounds the air vehicle 1403 horizontally and is essentially a circle in the X-Y plane with the air vehicle 1403 at the center. Let γ denote the angle of the arc 1413 on the yaw circle 1411 originating from the X-axis 1405 to a point 1415 on the yaw ring. The teachings will use a right-hand rule for angles, such that y is 0° on the positive X-axis, 90° on the positive Y-axis, 180° on the negative X-axis, and so forth. Angular rates will similarly use the right-hand rule. Let u(γ) 1417 and v(γ) 1419 denote respectively the optical flow seen by the air vehicle 1403 on the yaw circle 1411, with u 1417 parallel to the yaw circle 1411 and v 1419 oriented perpendicularly to the yaw circle 1411.

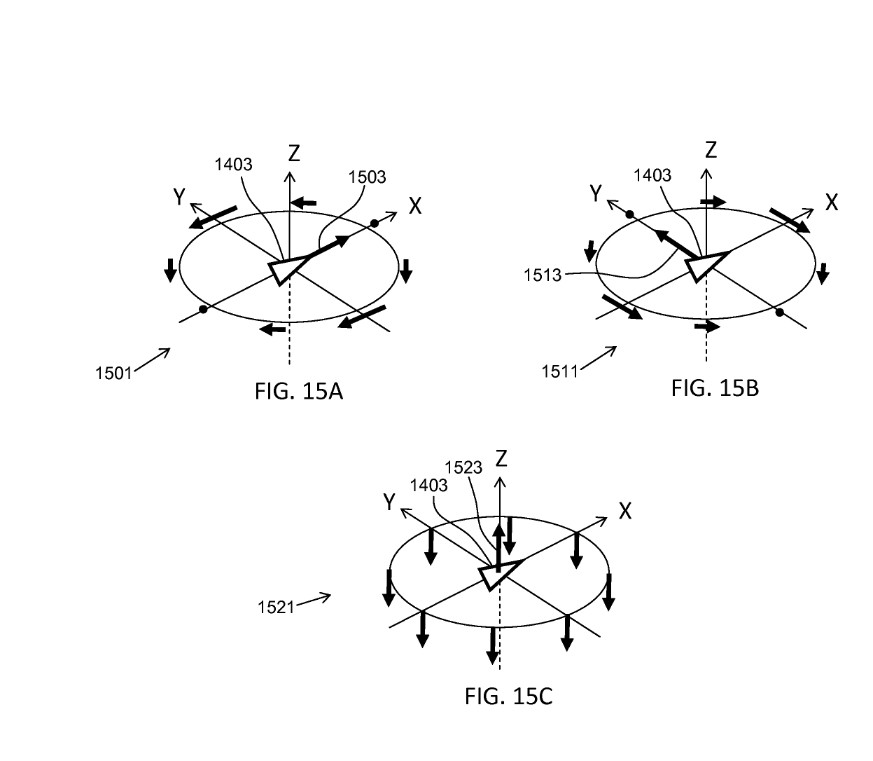

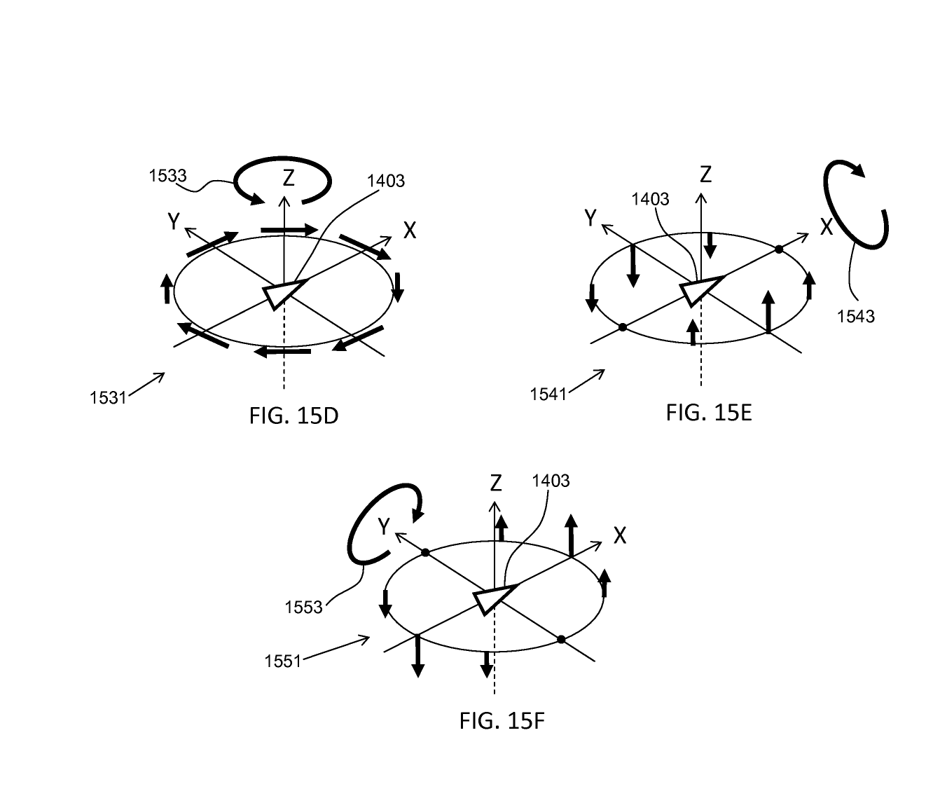

An air vehicle may undergo six basic motions, three associated with linear translation and three associated with rotation. FIGS. 15A through 15F show the type of optical flows that will be visible from the air vehicle 1403 undergoing these different motions. FIG. 15A shows an optical flow pattern 1501 resulting from forward motion 1503, or motion in the positive X direction. The optical flow u(γ) is zero at γ=0° and γ=180°, positive at γ=90°, and negative at γ=270°. The optical flow v(y) is zero. The actual optical flow magnitude will depend on both the forward velocity of the air vehicle 1403 and the distance to objects (not shown) in different directions, but can be described as loosely approximating a sine wave e.g. u(γ)≈k₁ sin(γ) where k₁ is generally proportional to the forward velocity of the air vehicle 1403 and inversely proportional to the distance between the air vehicle 1403 and objects in the environment.

FIG. 15B shows an optical flow pattern 1511 resulting from motion to the left 1513, or motion in the positive Y direction. The optical flow u(γ) is zero at γ=90° and γ=270°, positive at γ=180°, and negative at γ=0°. The optical flow v(γ) is zero. The actual optical flow magnitude will depend on both the Y-direction velocity of the air vehicle 1403 and the distance to objects in different directions, but can be described as loosely approximating a negative cosine wave e.g. u(γ)≈k₂ cos(γ) where k₂ is again generally proportional to the Y-direction velocity of the air vehicle 1403 and inversely proportional to the distance between the air vehicle 1403 and objects in the environment.

FIG. 15C shows an optical flow pattern 1521 resulting from motion upward 1523, e.g. positive heave or motion in the positive Z direction. The optical flow u(γ) is zero everywhere. The optical flow v(γ) is negative everywhere, with the actual value depending on both the Z-direction velocity of the air vehicle and the distance to objects in different directions. The optical flow v(γ) can be described as v(γ)≈−k₃.

FIG. 15D shows an optical flow pattern 1531 resulting from yaw rotation 1533 of the air vehicle 1403 e.g. counter-clockwise motion in the XY plane when viewed from a point on the positive Z axis. Let the yaw rate be denoted as ω_{g}, with a positive value indicating rotation as shown in the figure. The optical flow values will be u(γ)=−ω_{z} and v(γ)=0. In this case, the optical flow depends on only the yaw rate.

FIG. 15E shows an optical flow pattern 1541 resulting from roll rotation 1543 of the air vehicle 1403 e.g. rotation to the right about the X axis. Let the roll rate be denoted as ωₜ, with a positive value indicating rotation as shown in the figure. The optical flow u(γ) will be zero everywhere. The optical flow v(γ) will be zero at γ=0° and γ=180°, negative at γ=90°, and positive at γ=270°. The actual optical flow magnitude will be v(γ)=−ωₓ sin(γ), thus v(γ) can be described as a negative sine wave.

FIG. 15F shows an optical flow pattern 1551 resulting from pitch rotation 1553 of the air vehicle 1403 e.g. rotation about the Y axis. Let the pitch rate be denoted as ω_{y}, with a positive value indicating rotation as shown in the figure. Therefore, for illustrative purposes it will be understood that positive pitch rate corresponds to “pitching downward”, or equivalently “diving” if the air vehicle 1403 is a fixed-wing air vehicle. The optical flow u(γ) will be zero everywhere. The optical flow v(γ) will be zero at γ=90° and γ=270°, positive at γ=0°, and negative at γ=180°. The actual optical flow magnitude will be v(γ)=ω_{y} cos(γ), thus v(γ) can be described as a cosine wave.

It will be understood that the directions of the optic flow vectors shown in FIGS. 15A through 15F may be reversed if the motions are reversed. For example, if in FIG. 15C the air vehicle 1403 were descending rather than ascending, e.g. moving in the negative Z direction, then the corresponding optical flow vectors would be pointing up rather than down as shown. Similarly, if in FIG. 15D the air vehicle 1403 were rotating clockwise around the Z-axis rather than counterclockwise, the corresponding optical flow vectors would be pointing counterclockwise rather than clockwise as shown.

It will also be understood that if the air vehicle 1403 were undergoing a motion that is a weighted sum of the six basic motions depicted in FIGS. 15A through 15F, the resulting optical flow patterns would be a respectively weighted sum of the corresponding optical flow patterns of FIGS. 15A through 15F.

First Exemplary Method for Vision Based Hover in Place

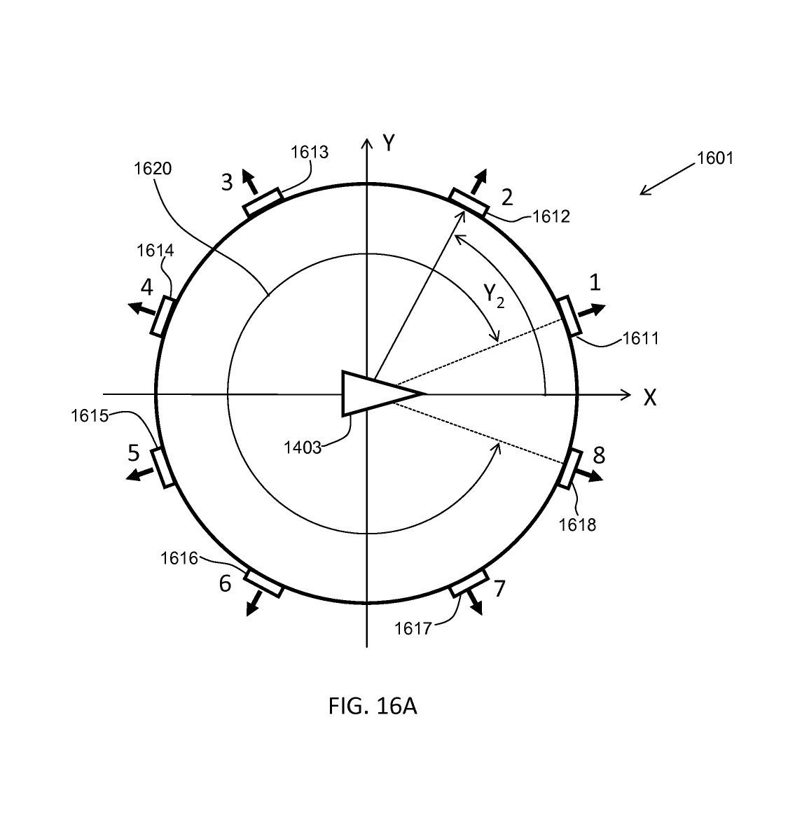

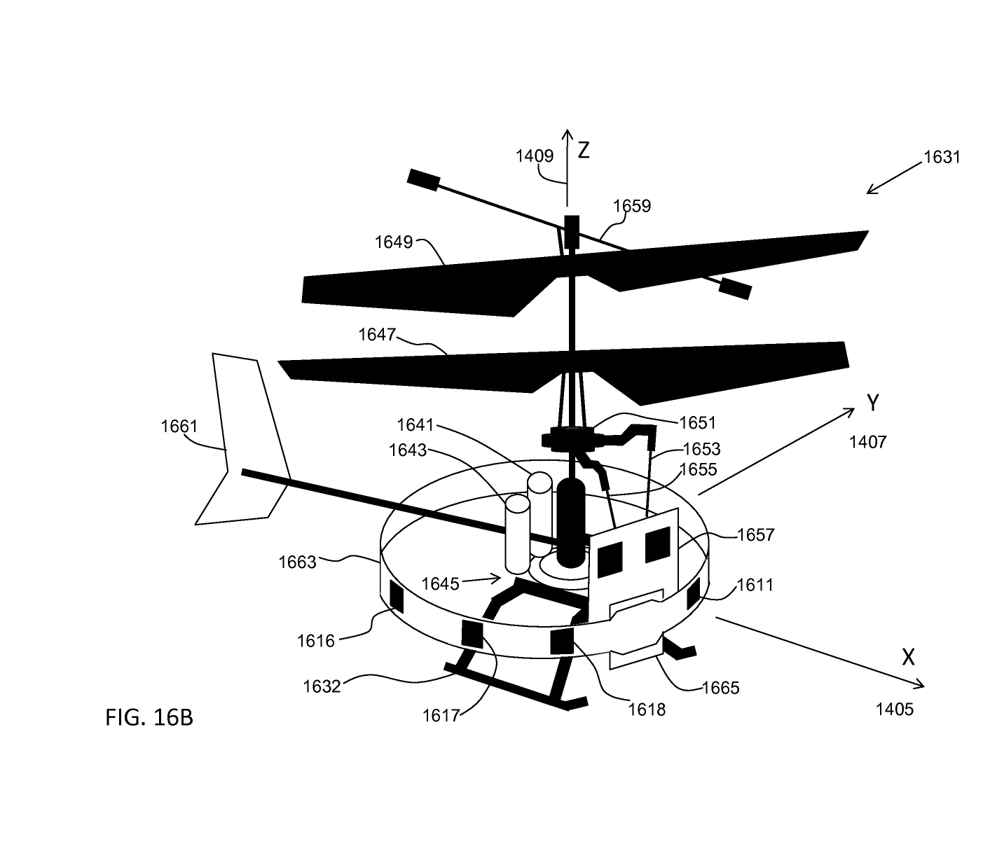

In the first exemplary method for vision based hover in place, the optical flow or visual motion in the yaw plane may be measured by a ring of sensors positioned around the vehicle to see in all directions. The optical flow values are used to compute visual displacement values, which may be the integrals of the optical flow values over time. In one variation, visual displacements are computed directly. FIG. 16A shows a sample sensor ring arrangement 1601 of eight sensors 1611 through 1618 for measuring optical flow, as viewed from above e.g. from a point on the positive Z axis. In the first exemplary method, each sensor i of the eight sensors has an associated viewing pose angle γᵢ and is capable of measuring visual motion uᵢ and vᵢ in its pose angle, where uᵢ is horizontal visual motion e.g. motion within the yaw plane and vᵢ is vertical visual motion in accordance with FIG. 14. It is beneficial for the fields of views of the individual sensors to abut or overlap but this is not required. This collection 1601 of visual motion sensors around the yaw axis may be referred to as a “sensor ring”. The collection 1601 of visual motion sensors may be placed on a yaw circle (e.g. 1411), though this is not required, and the pose angles γᵢ may be equally spaced, though this is not required.

FIG. 16B shows, for illustrative purposes, an exemplary contra-rotating coaxial rotary-wing air vehicle 1631, e.g. a helicopter, of the type that is used in the discussion of the first exemplary method for vision based hover in place. Air vehicle 1631 is an exemplary embodiment of the abstract air vehicle 1403 shown in FIGS. 14 through 16A. The construction and control of such helicopters will be understood by those skilled in the art of helicopter design. A book that may be referred to regarding the design of various unmanned aerial vehicles including micro air vehicles, and the contents of which are incorporated herein by reference, is “Unmanned Aerial Vehicles and Micro Aerial Vehicles” by Nonami, Kendoul, Suzuki, Wang, and Nakazawa, ISBN 978-4-431-53855-4. Two exemplary air vehicles that may be used include the Blade CX2 and the Blade mCX, both manufactured by the company E-flite, a brand of Horizon Hobby, Inc. based in Champaign, Ill. The air vehicle 1631 shown in FIG. 16B is based on the Blade mCX helicopter with the decorative canopy removed to expose inner electronics. The three reference axes X 1405, Y 1407, and Z 1409 are shown, with the X 1405 axis denoting the forward direction of the air vehicle 1631. Landing legs 1632 allow the air vehicle 1631 to rest on the ground when not flying. Heave motion (e.g. vertical motion in Z direction 1409) and yaw rotation (e.g. rotation around the Z axis 1409) may be controlled by two motors 1641 and 1643, which are connected through a gear system 1645 to respectively turn two rotors 1647 and 1649. The two rotors 1647 and 1649 spin in the opposite direction, and both push air downwards to provide lift. Heave motion may be controlled by increasing or decreasing the rotational speed of rotors 1647 and 1649 by a substantially similar amount. Yaw rotation may be controlled by spinning one of the rotors a different rate than the other—if one rotor spins faster than the other, then one rotor applies more torque than the other and the air vehicle 1631 rotates around the Z axis 1409 as a result.

Two servos (not shown) control the pose of the swash plate 1651 via two control arms 1653 and 1655. In the exemplary air vehicle 1631, the servos may be mounted on the rear side of a controller board 1657 mounted towards the front side of the air vehicle 1631, and are thus not visible in FIG. 16B. The pose of the swash plate 1651 causes the pitch of the lower rotor 1647 to vary with its yaw angle in a way that applies torque in the roll and/or pitch directions, e.g. around the X 1405 or Y 1407 axes. It will be understood that the controller board 1657 may be a hacked or modified version of the “stock” controller board that is delivered with such an air vehicle 1631 off-the-shelf, or the controller board 1657 may be a specially built circuit board to implement the control methods discussed herein.

A number of passive stability mechanisms may exist on air vehicle 1631 that may simplify its control. A stabilizer bar 1659 on the upper rotor 1649 may implement a passive feedback mechanism that dampens roll and pitch rates. Also when flying, both rotors will tend to cone in a manner that exhibits a passive pose stability mechanism that tends to keep the air vehicle 1631 horizontal. Finally a tail fin 1661 may dampen yaw rates through friction with air. These passive stability mechanisms may be augmented by a single yaw rate gyro (not shown), which may be mounted on the controller board 1657. The yaw rate measurement acquired by the yaw rate gyro may be used to help stabilize the air vehicle's yaw angle using a PID (proportional-integral-derivative) control rule to apply a differential signal to the motors 1641 and 1643 as described above.

As a result of these passive stability mechanisms, such helicopters tend to be stable in flight and will generally remain upright when the swashplate servos are provided with a neutral signal. These helicopters may be controlled in calm environments without having to actively monitor and control roll and pitch rates. Therefore, the teachings that follow will emphasize control of just the yaw rate, heave rate, and the swash plate servo signals. The term “heave signal” will refer to a common mode applied to the rotor motors 1641 and 1643 causing the air vehicle 1631 to ascend or descend as described above. The term “yaw signal” will refer to a differential mode applied to the rotor motors 1641 and 1643 causing the air vehicle 1631 to undergo yaw rotation. The term “roll servo signal” will refer to a signal applied to the servo that manipulates the swashplate 1651 in a manner causing the helicopter to undergo roll rotation, e.g. rotate about the X axis 1405, and therefore move in the Y direction 1407. The term “pitch servo signal” will refer to a signal applied to the servo that manipulates the swashplate 1651 in a manner causing the air vehicle 1631 to undergo pitch rotation, e.g. rotate about the Y axis 1407, and therefore move in the X direction 1405.

Also shown in FIG. 16B is a sensor ring 1663. In the first exemplary method, the sensor ring 1663 may contain eight vision sensors mounted on the ring to image the X-Y yaw plane in an omnidirectional manner, in the same manner as depicted in FIG. 16A. Four vision sensors 1611, 1616, 1617, and 1618 from FIG. 16A are visible in FIG. 16B, while the other four (e.g. 1612, 1613, 1614, and 1615) are on the far side of the air vehicle 1631 and are thus hidden. Also shown is a vision processor board 1665 which is attached to the sensor ring 1663 and also to the controller board 1657. Further details on these items will be discussed below.

In the first exemplary method, the sensors on the sensor ring are capable of measuring visual motion displacements, or equivalently “visual displacements”. A visual displacement is similar to optical flow in that both are a measure of visual motion. The difference is that optical flow represents an instantaneous visual velocity, whereas a visual displacement may represent a total visual distance traveled. Visual displacement may thus be considered to be an integral of optical flow over time. For example, optical flow may be measured in degrees per second, radians per second, or pixels per second, whereas visual displacement may be respectively measured in total degrees, radians, or pixels traveled. Methods of measuring visual displacement using optical flow and other algorithms will be discussed below.

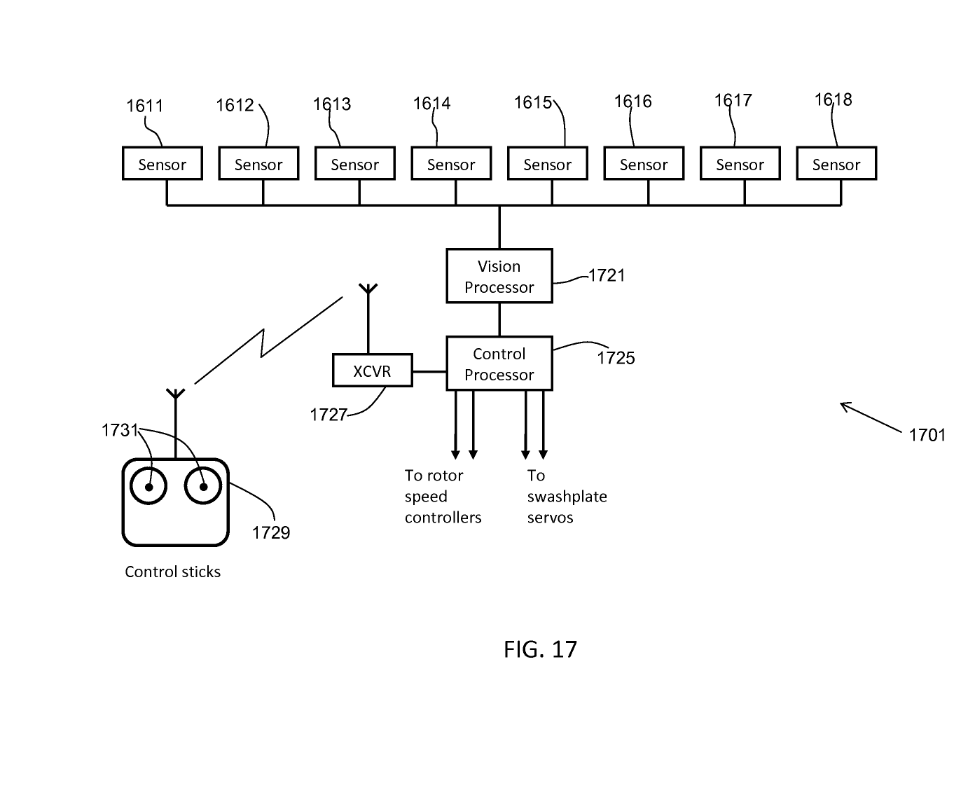

FIG. 17 shows a block diagram of an exemplary vision based flight control system 1701 that may be used to control an air vehicle 1631. The eight aforementioned vision sensors 1611 through 1618 are connected to a vision processor 1721. The vision processor 1721 may be located on the vision processor board 1665 shown in FIG. 16B. In the exemplary system 1701 each of these vision sensors 1611 through 1618 is an image sensor having a 64×64 resolution and a lens positioned above the image sensor, (as shown in FIG. 2C), to form an image onto the image sensor, and the vision processor 1721 may be a microcontroller or other processor. This resolution is for illustrative purposes and other resolutions may be used. In the exemplary system 1701 the vision sensors 1611 through 1618 may be implemented using any of the three aforementioned exemplary image sensors. The image sensors and optics may be mounted on a flexible circuit board and connected to the vision processor 1721 using techniques disclosed in the aforementioned US patent application 2008/0225420 entitled “Multiple Aperture Optical System”, in particular in FIGS. 10A, 10B, and 11. The image sensors and optics may be arranged in a manner as shown in FIG. 16B.

The vision processor 1721 operates the image sensors 1611 through 1618 to output analog signals corresponding to pixel intensities, and uses an analog to digital converter (not shown) to digitize the pixel signals. It will be understood that the vision processor 1721 has access to any required fixed pattern noise calibration masks, in general at least one for each image sensor, and that the processor 1721 applies the fixed pattern noise calibration mask as needed when reading image information from the image sensors. It will also be understood that when acquiring an image, the vision processor accounts for the flipping of the image on an image sensor due to the optics, e.g. the upper left pixel of an image sensor may map to the lower right area of the image sensor's field of view. The vision processor 1721 then computes, for each image sensor, the visual displacement as seen by the image sensor.

The vision processor 1721 then outputs one or more motion values to a control processor 1725. The control processor 1725 may be located on the control board 1657 of FIG. 16B. The nature of these motion values will be described below. The control processor 1725 implements a control algorithm (described below) to generate four signals that operate the air vehicle's rotors and swashplate servos, using the motion values as an input. The control processor 1725 may use a transceiver 1727 to communicate with a base station 1729. The base station 1729 may include control sticks 1731 allowing a human operator to fly the air vehicle 1631 when it is not desired for the air vehicle to hover in one position.

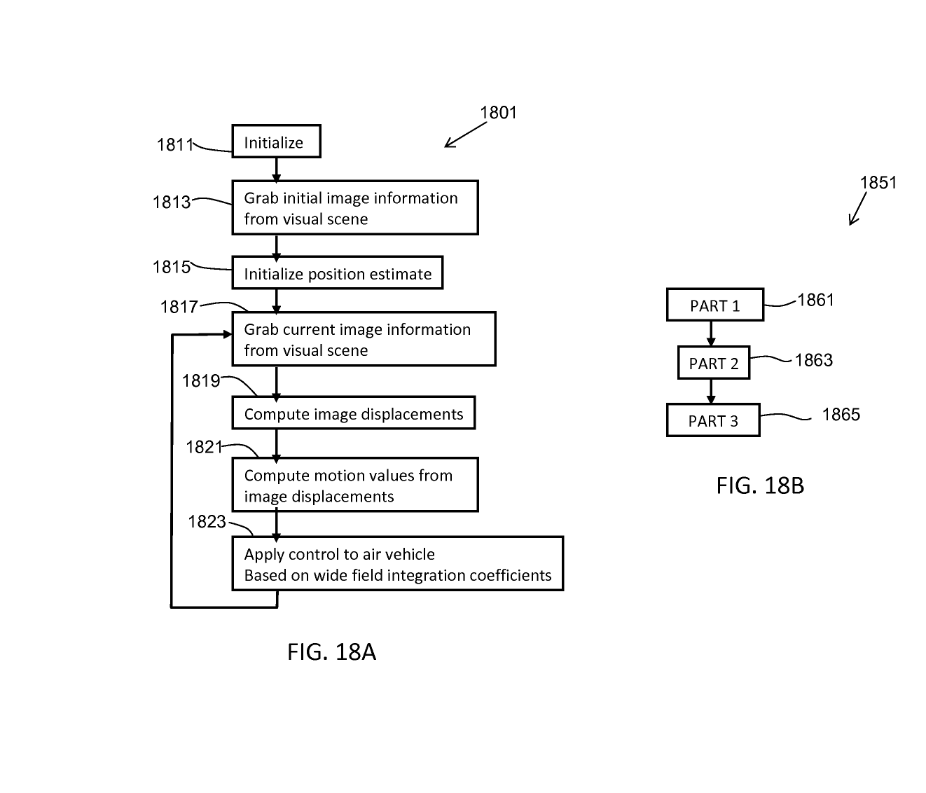

FIG. 18A shows the first exemplary method 1801 for vision based hover in place. The first three steps 1811, 1813, and 1815 are initialization steps. The first step 1811 is to perform general initialization. This may include initializing any control rules, turning on hardware, rotors, or servos, or any other appropriate set of actions.

The second step 1813 is to grab initial image information from the visual scene. For example, this may include storing the initial images acquired by the image sensors 1611 through 1618. This may also include storing initial visual position information based on these images.

The third step 1815 is to initialize the position estimate. Nominally, this initial position estimate may be “zero” to reflect that it is desired for the air vehicle to remain at this location.

The fourth through seventh steps 1817, 1819, 1821, and 1823 are the recurring steps in the algorithm. One iteration of the fourth, fifth, and sixth steps may be referred to as a “frame”, and one iteration of the seventh step may be referred to as a “control cycle”. The fourth step 1817 is to grab current image information from the visual scene. This may be performed in a similar manner as the second step 1813 above.

The fifth step 1819 is to compute image displacements based on the image information acquired in the fourth step 1817. In this step, for each sensor of the eight sensors 1611 through 1618 the visual displacement between the initial visual position and the current visual position is computed.

The sixth step 1821 is to compute the aforementioned motion values based on the image displacements computed in the fifth step 1819.

The seventh step 1823 is to use the computed motion values to control the air vehicle 1631. For some implementations, the resulting control signals may be applied to the air vehicle 1631 once every frame, such that the frame rate and the control update rate are equal. For other implementations, a separate processor or even a separate processor thread may be controlling the air vehicle 1631 at a different update rate. In this case the seventh step 1823 may comprise just sending the computed motion values to the appropriate processor or processor control thread.

The above seven steps will now be described in greater detail. In the first exemplary method 1801, the first step is to perform a general initialization. The helicopter and all electronics are turned on if they are not on already.

In the exemplary embodiment, the second step 1813 is to grab initial image information from the eight image sensors 1611 through 1618. For each sensor i, a horizontal image Hᵢ^{o} and a vertical image Vᵢ^{o} is grabbed in the following manner: Let Jᵢ(j,k) denote the pixel (j,k) of the 64×64 raw image located on image sensor i. The indices j and k indicate respectively the row and the column of the pixel. This 64×64 image J, may then be converted into a 32 element linear image of superpixels using binning or averaging. Such 32 element linear images of superpixels may be acquired using the aforementioned techniques described with the three exemplary image sensors. The first superpixel of Hᵢ^{o} may be set equal to the average of all pixels in the first two columns of J, the second superpixel of Hᵢ^{o} may be set equal to the average of all pixels in the third and fourth columns of Jᵢ, and so forth, until all 32 elements of Hᵢ^{o} are obtained from the columns of J. Entire columns of the raw 64×64 image J, may be binned or averaged together by setting V1 611 through V8 618 all to digital high. Vertical image Vᵢ^{o} may be constructed in a similar manner: The first superpixel of Vᵢ^{o} may be set equal to the average of the first two rows of J, the second superpixel to the average of the third and fourth rows, and so forth. Entire rows of the raw 64×64 image may be binned or averaged together by setting H1 601 through H8 608 all to digital high. The images Hᵢ^{o} and Vᵢ^{o} therefore will respectively have a resolution of 32×1 and 1×32. These images may be referred to as “reference images”.

It is possible to generate the horizontal and vertical images Hᵢ^{o} and Vᵢ^{o} in other ways. For example, it is possible to acquire all 4096 pixels from the raw 64×64 image Jᵢ, and then arithmetically calculate the horizontal and vertical images by averaging rows and columns as appropriate. Another possibility is to use any image sensor having a binning capability. Aside from the above three exemplary image sensors, other example image sensors that have binning capability are described in the following list of U.S. Patents, the contents of which are incorporated by reference: U.S. Pat. No. 5,949,483 by Fossum, Kemeny, and Pain; U.S. Pat. No. 7,408,572 by Baxster, Etienne-Cummings, Massie, and Curzan; U.S. Pat. No. 5,471,515 by Fossum, Mendis, and Kemeny; and U.S. Pat. No. 5,262,871 by Wilder and Kosonocky.

The third step 1815 is to initialize the position estimate. In the exemplary method, this may be performed for each sensor i by setting accumulated displacement signals uᵢ^{o}=0 and vᵢ^{o}=0.

The fourth step 1817 is to grab current image information from the visual scene. For each image sensor i, grab current horizontal image Hᵢ and current vertical image Vᵢ using the same techniques as in the second step 1813.

The fifth step 1819 is to compute image displacements based on the images Hᵢ, Vᵢ, Hᵢ^{o}, and Vᵢ^{o}. Refer to FIG. 18B, which shows a three part process 1851 for computing image displacements. In the first part 1861, an optical flow algorithm is used to compute the displacement uᵢ between Hᵢ^{o} and Hᵢ, and the displacement vᵢ between Vᵢ^{o} and Vᵢ. These displacements may be computed using a one dimensional version of the aforementioned optical flow algorithm by Srinivasan. This is because the rectangular nature of the superpixels used to compute Hᵢ, Vᵢ, Hᵢ^{o}, and Vᵢ^{o} preserve visual motion along the orientation of the line image, as discussed in the aforementioned U.S. Pat. No. 6,194,695. The following segment of calculations, written in the MATLAB programming language, show how to uᵢ may be computed using Hᵢ and Hᵢ^{o}, with the variable “Hi” storing Hᵢ, the variable “Hoi” storing Hᵢ^{o}, and the variable “ui” storing the result uᵢ.

fm=length(Hoi);
ndxs=2:fm-1;
f0=Hoi(ndxs);
fz=Hi(ndxs);
f1=Hoi(ndxs-1);
f2=Hoi(ndxs+1);
top=sum((fz-f0).*(f2-f1));
bottom=sum((f2-f1).̂2);
ui=−2*top/bottom;

Alternatively, uᵢ may be computed using a one-dimensional version of the aforementioned optical flow algorithm by Lucas and Kanade. The variable vᵢ may be computed from Vᵢ and Vᵢ^{o} in the same similar manner. It will be understood that although the above calculations are described above in the MATLAB programming language, they can be rewritten in any other appropriate programming language. It will also be understood that both sets of calculations written above are capable of obtaining a displacement to within a fraction of a pixel of accuracy, including displacements substantially less than one pixel. It is beneficial for the method 1801 to be performed at an adequately fast rate that the typical displacements measured by the above MATLAB script (for computing ui from Hoi and Hi) are less than one pixel. The selection of the frame rate may therefore depend on the dynamics of the specific air vehicle.

An alternative is to use a one dimensional version of the aforementioned optical flow algorithm by Lucas and Kanade. For computing this may be performed by using the following MATLAB function LK1, with input array “X1” being set to Hᵢ^{o}, input array “X2” being set to Hᵢ, and uᵢ being set to the resulting value “Shift”:

```
% ===================================================
function [Shift] = LK1(X1, X2)
% X1 is first image
% X2 is second image
% Shift is the 1D optical flow in pixels
SearchImg = X1;
CurImg = X2;
% determine dimensions and setup
InWidth = size(CurImg, 2);
Inset = 1;
RegWidth = InWidth − Inset*2;
dIx = zeros(1, RegWidth);
dIt = zeros(1, RegWidth);
% compute spatial derivatives
for c = 1 : RegWidth
    dIx(c) = (CurImg(c+Inset+1) − CurImg(c+Inset−1)) / 2;
end
% compute temporal derivative
for c = 1 : RegWidth
    dIt(c) = double(CurImg(c+Inset) − SearchImg(c+Inset));
end
% compute combination arrays used in computation
dIxSq = dIx .* dIx;
dIxdIt = dIx .* dIt;
% clear sums
dIxSqSum = 0;
dIxdItSum = 0;
% process window
for c = 1 : RegWidth
    % compute sums
    dIxSqSum = dIxSqSum + dIxSq(c);
    dIxdItSum = dIxdItSum + dIxdIt(c);
end
% store “A” matrix for computation
AMat = dIxSqSum;
% check for non-singular matrix
if (AMat ~= 0)
    % compute pixel shift result
    Shift = (AMat\hat{ }−1) * −dIxdItSum;
% matrix is singular
else
    % zero out result
Shift = 0;
end
% ===================================================
```

The second part 1863 of the three part process 1851 is to update Hᵢ^{o}, uᵢ^{o}, uᵢ, Vᵢ^{o}, vᵢ^{o}, and vᵢ if necessary. In the exemplary embodiment, this is performed if the magnitude of uᵢ or vᵢ is greater than a predetermined threshold θ. It is beneficial for the value of θ to be less than one pixel, for example about a quarter to three quarters of a pixel. More specifically:

```
if |uᵢ| > θ or |vᵢ| > θ then
        uᵢ⁰ = uᵢ⁰ + uᵢ ;
        uᵢ = 0 ;
        Hᵢ⁰ = Hᵢ ;
        vᵢ⁰ = vᵢ⁰ + vᵢ ;
        vᵢ = 0 ;
        Vᵢ⁰ = Vᵢ ;
end
```

The third part 1865 of the three part process 1851 is to compute the resulting total displacements. Let uᵢ^{d} and vᵢ^{d} be the respective total displacements in the u 1417 and v 1419 directions. These values may be set as:

uᵢ^{d}=uᵢ⁰+uᵢ

vᵢ

The sixth step 1821 is to compute the motion values based on the image displacements computed in the previous step 1819. In the exemplary embodiment, these may be computed based on the displacement values uᵢ^{d} and vᵢ^{d}. A total of six motion values may be computed based on the optical flow patterns shown above in FIGS. 15A through 15F. These motion values are, with N being the number of sensors on the yaw ring (nominally eight in the currently discussed exemplary method):

$${a}_{0} = \frac{1}{N} {\sum }_{i = 1 … N} {u}_{i}^{d}$$

$${a}_{1} = - \frac{1}{N} {\sum }_{i = 1 … N} {u}_{i}^{d} cos ( {γ}_{i} )$$

$${b}_{1} = \frac{1}{N} {\sum }_{i = 1 … N} {u}_{i}^{d} sin ( {γ}_{i} )$$

$${c}_{0} = - \frac{1}{N} {\sum }_{i = 1 … N} {v}_{i}^{d}$$

$${c}_{1} = \frac{1}{N} {\sum }_{i = 1 … N} {v}_{i}^{d} cos ( {γ}_{i} )$$

$${d}_{1} = - \frac{1}{N} {\sum }_{i = 1 … N} {v}_{i}^{d} sin ( {γ}_{i} )$$

It will be understood that each of these motion values is effectively an inner product between the visual displacements uᵢ^{d} and vᵢ^{d} and the respective optical flow pattern from one of FIGS. 15A through 15F. These motion values are similar to the wide field integration coefficients described in the aforementioned papers by Humbert. Optionally, it may be beneficial to exclude from the above six motion values any visual displacements uᵢ^{d} and vᵢ^{d} obtained by a sensor i having a low contrast or otherwise poor quality image—this may eliminate potentially noisy optical flow measurements from the six computed motion values.

These six motion values can serve as a measure of how far the air vehicle 1403 has drifted from the original location. The a₀ motion value is a measure of the yaw rotation, e.g. rotation about the Z axis 1409. The a₁ motion value is a measure of horizontal drift in the sideways direction, e.g. drift parallel to the Y axis 1407. The b₁ motion value is a measure of horizontal drift in the forward-backward direction, e.g. drift parallel to the X axis 1405. The c₀ motion value is a measure of drift in the heave direction, e.g. drift parallel to the Z axis 1409. The c₁ motion value is a measure of pitch rotation, e.g. rotation about the Y axis 1407. Finally the d₁ motion value is a measure of roll rotation, e.g. rotation about the X axis 1405. It will be understood that the three motion values associated with translation, e.g. a₁, b₁, and c₀ express a distance traveled that is relative to the size of the environment, and not necessarily an absolute distance traveled. Suppose the air vehicle 1631 is in the center of a four meter diameter room, and drifts upwards by 1 meter, and as a result c₀ increases by a value “1”. If the same air vehicle 1631 were placed in the center of a two meter diameter room, and drifted upwards by 1 meter, c₀ may increase by a value of “2”. It will be understood that the relative nature of the motion values a₁, b₁, and c₀ will generally not be an issue for providing hover in place because when an air vehicle is hovering in place, it is generally staying within the same environment. Similarly, if the air vehicle's position is perturbed, the result will be a change of the motion values from zero (or their original values). Controlling the air vehicle to bring the motion values back to zero (or their original values) may then bring the air vehicle back to its original location to recover from the position perturbation.

Obtaining motion values in the manner shown above has several advantages. First, monitoring a wider visual field increases the chance of finding visual texture that can be used to provide motion estimate. If the imagery seen by one or several of the sensors is poor or lacking in contrast, the above method may still be able to provide a useful measurement. Second, if the individual visual displacement measurements from individual sensors are corrupted by noise that is independent for each sensor, then the effect of the noise on the resulting motion values is reduced by the central limit theorem.

It is beneficial for the sensors 1611 through 1618 to be arranged to cover a wide field of view as shown in FIGS. 16A and 16B, preferably substantially omnidirectional as shown. This may allow sampling of visual displacements and thus computation of motion values to be based on more diverse set of environmental visual features, and thus improve the robustness of the exemplary method 1801. Refer back to FIG. 16A. It is possible to define an angle, for example angle 1620, that contains all of the sensors of a sensor arrangement 1601. Let us define this angle as the “field of view” of the sensor arrangement 1601. In the exemplary sensor arrangement 1601 of FIG. 16A, and the sensor ring 1663 of FIG. 16B, the field of view is well in excess of 180 degrees, and is in fact greater than 270 degrees and close to 360 degrees.

It will be understood that although it is beneficial for the sensor ring 1663 shown in FIG. 16B to be omnidirectional, this is not a requirement. The individual sensors 1611 through 1618 can have non-overlapping fields of view and the above algorithm will still function, although the displacement measurements may be less robust than what is obtained with a more complete coverage of the field of view.

If the air vehicle being used is passively stable in the pitch and roll directions, then it will not be necessary to measure pitch and roll displacements. In this case, the step of computing motion values c₁ and d₁ may be omitted. Similarly, if the air vehicle has a yaw rate gyro, then the yaw angle may be controlled additionally or instead by the measured yaw rate.

The seventh step 1823 is to use the motion values to control the air vehicle. In the exemplary embodiment, this may be performed using a proportional-integral-derivative (PID) control rule. PID control is a well-known algorithm in the art of control theory. The yaw angle of the air vehicle may be controlled by using a PID control rule to try to enforce a₀=0, by applying the control signal to the rotor motors in a differential manner as described above. The heave of the air vehicle may be controlled by using a PID control rule to try to enforce c₀=0, by applying the control signal to the rotor motors in a common mode manner as described above. The drift parallel to the X direction 1405 may be controlled by using a PID control rule to try to enforce b₁=0, by applying the control signal to the swashplate servo that adjusts pitch angle. Finally the drift in the Y direction may be controlled by using a PID control rule to try to enforce a₁=0, by applying the control signal to the swashplate servo that adjusts roll angle. Keeping these motion values generally constant has the effect of keeping the air vehicle in one location since if all the motion values are constant, then generally the measured sensor displacements are being kept constant, and therefore the air vehicle is generally not moving. Similarly keeping these motion values all near zero has the effect of keeping the air vehicle in its original location at Step 1813.

For purposes of definition, we will use the term that a motion value is kept “substantially constant” to mean that the associated state value is allowed to vary within a limited range when no external perturbations (e.g. wind gusts) are applied. For example, if it is said that the yaw angle is kept substantially constant, then the actual yaw angle of the air vehicle may vary with a range of ±θ, where θ is a reasonable threshold for an application, which may be one degree, ten degrees, or another appropriate value. Likewise, if it is said that the position of an air vehicle is kept substantially constant, then the air vehicle may move around within a sphere centered at its original location, with a reasonable radius of the sphere for a given application and environment. The allowable size of the sphere may be increased for larger environments.

It will be understood that the use of the aforementioned image interpolation algorithm is for illustrative purposes and that a variety of other optical flow or visual motion algorithms, as well as a variety of other array sizes, may be used. For example, rather than binning the raw 64×64 array down into 32×1 or 1×32 images, it is possible to form 64×8 and 8×64 images using respectively 1×8 and 8×1 superpixels, and then obtain eight one dimensional optical flow measurements from each of these images, to produce a total of 64 optical flow measurements in each direction over the eight vision sensors. Similarly the image from each sensor may be divided into a two dimensional array, for example by downsampling the 64×64 raw pixel array into 8×8 arrays. Then a direct two dimensional algorithms, for example the aforementioned algorithm “ii2’, may be used to directly compute both horizontal and vertical displacements uᵢ and vᵢ. It will be understood that yet other variations are possible.

Second Exemplary Method for Vision Based Hover in Place

A number of variations may be made to the first exemplary method 1801 by using different methods of computing visual displacements. An example is the second exemplary method for vision based hover in place, which shall be described next. The second exemplary method may require a faster processor and faster analog to digital converter (ADC) than the first exemplary method, but does not require the use of an image sensor with binning capabilities. The second exemplary method uses the same steps shown in FIGS. 18A and 18B, but modified as follows:

The first step 1811 is unchanged. In the second step 1813, for each sensor of the eight sensors 1611 through 1618 all pixels of the 64×64 image are digitized and acquired. Let Rᵢ denote the 64×64 matrix that corresponds to the raw 64×64 image of sensor i. A patch of pixels Wᵢ is then selected near the middle of the image Rᵢ. The patch may be an 11×11, 13×13, or other similar block size subset of the raw pixel array Rᵢ. It will be understood that non-square patch sizes, e.g. 11×13 or other, may be used. Let the variable wₛ denote the size of the block in one dimension, so that the size of patch Wᵢ is wₛ×wₛ. The patch of pixels Wᵢ may be chosen using a saliency algorithm or a corner detection algorithm, so that it is easy to detect if the block moves horizontally or vertically in subsequent frames. The implementation of saliency or corner detection algorithms is a well-known art in image processing. This block is stored in matrix Let the values mᵢ⁰ and nᵢ⁰ respectively store the vertical and horizontal location of the block for example by setting and equal to the pixel location of the upper left pixel of block Wᵢ in the raw 64×64 image Rᵢ. Additionally, set mᵢ=mᵢ⁰ and nᵢ=nᵢ⁰.

The third step 1815 is unchanged. In the fourth step 1817, the 64×64 matrices Rᵢ corresponding to each sensor i are again acquired.

The fifth step 1819 is to compute image displacements based on the current matrices Rᵢ. This step may be performed in three parts that are similar to the three parts 1851 discussed in the first exemplary method. In the first part 1861, a block tracking algorithm is used to determine to where block Wᵢ has moved in the current image Rᵢ. This may be performed by searching around previous location defined by mᵢ and nᵢ for the wₛ×wₛ window that best matches W. This may be performed using a sum of squares of differences (SSD) match metric, minimum absolute difference (MAD) metric, variation of differences (VOD), correlation metrics, or other metrics. The implementation of block matching algorithms for sensing visual motion is a well-known and established art in image processing. Set mᵢ and nᵢ to the new best match locations. The values uᵢ and vᵢ may be computed as follows:

uᵢ=nᵢ−nᵢ⁰

vᵢ=−(mᵢ−mᵢ⁰)

The negative sign in the equation for vᵢ is due to the convention that top-most row of pixels of a matrix are given the lowest row index number.

The second part 1863 of the three-step process 1851 is to update Wᵢ, mᵢ⁰, nᵢ⁰, uᵢ⁰, and vᵢ⁰ as needed. More specifically:

```
if mᵢ⁰ ≦ θ or nᵢ⁰ ≦ θ or mᵢ⁰ ≧ 64 − θ − wₛ or nᵢ⁰ ≧ 64 − θ − wₛ then
        uᵢ⁰ = uᵢ⁰ + uᵢ ;
        vᵢ⁰ = vᵢ⁰ + vᵢ ;
                uᵢ = 0 ;
                vᵢ = 0 ;
                Find a new window Wᵢ in the current matrix Rᵢ
                set mᵢ⁰ and nᵢ⁰ to the location of the new window Wᵢ
end
```

The purpose of the above set of steps is to handle the situation that occurs if the window Wᵢ is about to move off the image Rᵢ. In this case, the accumulated displacements uᵢ⁰ and vᵢ⁰ are updated and a new window Wᵢ is grabbed using the same techniques as above in the second step 1813. The threshold θ may be a value such as one, two, three, or another number of pixels depending on parameters such as the air vehicle's speed, the frame rate at which the system operates, or the scale of the environment in which the air vehicle is operating. It is beneficial for θ to be greater than the search radius used to search for the motion of the block Wᵢ from frame to frame.

The third part 1865 of the three part process 1851 may be performed in the same manner as above. The sixth step 1821 and seventh step 1823 may be performed in the same manner as in the above exemplary algorithm, however the control constants for the PID control rules may need to be modified. For the viewing pose angle γᵢ associated with each block one may use just the pose angle of the respective sensor i, or one may use a pose angle constructed from both the pose angle of sensor i and the (mᵢ,nᵢ) location of the block in image Rᵢ.

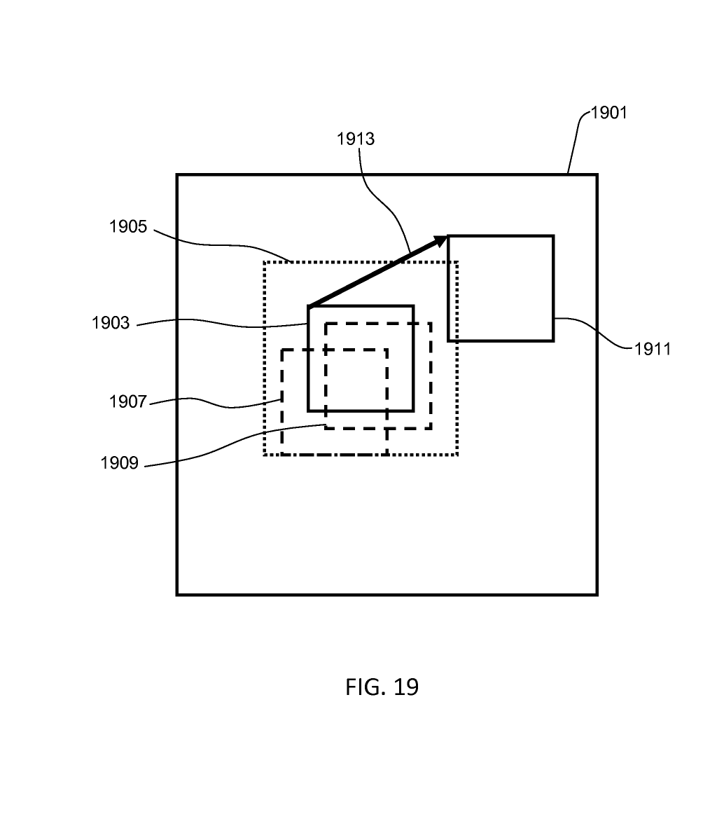

For a graphical depiction of block matching, refer to FIG. 19, which depicts a block of pixels being tracked. The large box 1901 depicts the raw 64×64 image Rᵢ acquired by vision sensor i. Box 1903 depicts, for illustrative purposes, the location of the original wₛ×wₛ patch of pixels Wᵢ acquired in step 1813. When Step 1817 is reached, the air vehicle may have moved, causing the texture associated with patch Wᵢ 1903 to have moved. Box 1905 depicts a search space around box 1903. Box 1907 is one of the wₛ×wₛ patch of pixels within the search space 1905 that is examined as a possible match for Wᵢ 1903. Box 1909 is another wₛ×wₛ patch of pixels examined. The wₛ×wₛ patch of pixels that best matches Wᵢ is the new location of the block. At the next iteration of the algorithm, the search space 1905 is centered around the most recent location of block Suppose after a number of iterations the block Wᵢ has moved to location 1911. The displacements uᵢ and vᵢ may then be computed from the displacement vector 1913 between the original location 1903 of the block and the current location 1911.

The above variation will be particularly useful if the air vehicle is operating in a controlled environment in which visual features are deposited on the walls to facilitate the selection of a salient block to track. Sample visual features may include dark or bright patterns on the walls, or may include bright lights. If bright lights are used, it may be possible to eliminate the steps of extracting blocks Wᵢ from the raw images Rᵢ and instead look for bright pixels which correspond to the lights. This variation is discussed below as the fourth exemplary algorithms.

A variation of the second exemplary method may be implemented by tracking more than one patch of pixels in each image sensor. This variation may be appropriate if the environment surrounding the air vehicle is textured enough that such multiple patches per image sensor may be acquired. In this case the motion values may be computed using all of the pixel patches being tracked.

Third Exemplary Method for Vision Based Hover in Place

The third exemplary method for vision based hover in place is essentially identical to the first exemplary method 1801 with one change: The fifth step 1819 may be modified so that the optical flows uᵢ and vᵢ obtained every frame are directly integrated in order to obtain uᵢ⁰ and vᵢ⁰. More specifically, the fifth step 1819 may then be implemented as follows:

uᵢ⁰=uᵢ⁰+uᵢ;

uᵢ=0;

Hᵢ⁰=Hᵢ;

vᵢ⁰=vᵢ⁰+vᵢ;

vᵢ=0;

Vᵢ⁰=Vᵢ;

It will understood that this variation is mathematically equivalent to the first exemplary method when θ=0, e.g. the variables Hᵢ⁰, uᵢ⁰, Vᵢ⁰, and vᵢ⁰ are always updated every frame. This variation will achieve the intended result of providing hover in place, however in some applications it may have the disadvantage of allowing noise in the individual optical flow measurements to accumulate and manifest as a slow drift or random walk in the air vehicle's position.

Variations to the First Three Exemplary Methods

A number of other variations of the three exemplary methods of vision based hover in place may be made. For example, if the air vehicle is not passively stable in the roll or pitch directions, or if the air vehicle experiences turbulence that disturbs the roll and pitch angles, the c₁ and d₁ motion values may be used to provide additional control input, mixed-in, to the appropriate swashplate servos.

Another variation is to mount the sensor ring along a different plane. The mounting position in the X-Y plane, e.g. the yaw plane, has already been discussed above. Another possible mounting position is in the X-Z plane, e.g. the pitch plane. In this mounting location, the a₀ motion value indicates change in pitch, the a₁ motion value indicates drift in the heave or Z direction, the b₁ motion value indicates drift in the X direction, the c₀ motion value indicates drift in the Y direction, the c₁ motion value indicates change in yaw, and the d₁ motion value indicates change in roll. Yet another possible mounting location is in the Y-Z plane, e.g. the roll plane. In order to increase the robustness of the system, it is possible to mount multiple sensor rings in two or all of these directions, and then combine or average the roll, pitch, yaw, X, Y, and Z drifts detected by the individual sensor rings.

It is possible to mount a sensor ring in positions other than one of the three planes discussed above. However in this case it may be necessary to transform the measured values a₀, a₁, b₁, c₀, cᵢ, and d₁ to obtain the desired roll, pitch, yaw, X, Y, and Z drifts.

It will be understood that a number of other variations may be made to the above exemplary embodiments that would provide HIP capability. For example, clearly the array of sensors need not be literally placed in a physical ring such as shown in FIG. 16B, and may instead be mounted in any manner providing a wide field of view. More or fewer than eight vision sensors may be used. It is also possible to achieve the same benefits by using just one or two wide field of view cameras, which may be implemented using wide-angle optics such as fisheye lenses or catadioptric optics, for example by aiming the camera at a curved mirror as discussed in the aforementioned U.S. Pat. No. 5,790,181. In this variation, the entire field of view of each camera may be divided into individual regions with each region looking in a different direction and producing an independent visual motion measurement. It will be beneficial to account for the distortion of such optics when computing the effective pose angles for the different visual motion measurements. It is also possible to use the techniques described in the aforementinoed published US Patent Application 2011/0026141 by Barrows entitled “Low Profile Camera and Vision Sensor”.

Exemplary Method of Control Incorporating an External Control Source Including Human Based Control

The above three exemplary methods of providing vision based hover in place focus on methods to keep the air vehicle hovering substantially in one location. If the air vehicle is perturbed, due to randomness or external factors such as a small gust of air, the above methods may be used to recover from the perturbation. It is desirable for other applications to integrate external control sources including control sources from a human operator. The external control source may then provide general high-level control information to the air vehicle, and the air vehicle would then execute these high-level controls while still generally maintaining stability. For example, the external control source may guide the air vehicle to fly in a general direction, or rotate in place, or ascend or descend. Alternatively a human operator, through control sticks (e.g. 1731) may issue similar commands to the air vehicle. This next discussion will address how such higher level control signals from an external control source (whether human or electronic) may be integrated with the above exemplary methods of providing vision-based hover in place. For the purposes of illustration, we will assume that four external control signals are possible that correspond to the four motion types associated with the four motion values a₀, a₁, b₁, and c₀. In other words, if the external control input is from control sticks 1731, then the control sticks may respectively indicate yaw rotation, X motion, Y motion, and heave motion. Below we discuss two methods of incorporating an external control signal into hover in place, which may be applied to any of the aforementioned three methods of vision based hover in place.

One method of incorporating an external control signal is to add an offset to the computed motion values a₀, a₁, b₁, and c₀. For example, adding a positive offset to the value c₀, and sending the sum of c₀ and this offset to the PID control rule modifying heave, may give the heave PID control rule the impression the air vehicle is too high in the Z direction. The PID algorithm would respond by descending e.g. traveling in the negative Z direction. This is equivalent to changing a “set point” associated with the c₀ motion value and thus the air vehicle's heave state. If a human were providing external control input via control sticks (e.g. 1731), then the offset value added to the c₀ parameter may be increased or decreased every control cycle depending on the human input to the control stick associated with heave. The air vehicle may similarly be commanded to rotate in the yaw direction (about the Z axis) or drift in the X and/or Y directions by similarly adjusting respectively the a₀, b₁, and a₁ motion values.

A second method of incorporating an external control signal is to modify Step 1823 to overwrite one or more of the motion values computed in Step 1821 with new values based on the external control signal. Suppose the external control signal were provided by a human operator via control sticks (e.g. 1731). When the control sticks are neutral, e.g. the human is not providing input, then the Step 1823 may operate as described above. When one of the control sticks is not neutral, then Step 1823 may be modified as follows: For all external control inputs that are still neutral, the corresponding motion values computed in Step 1821 may be untouched. However for all external control inputs that are not neutral, the corresponding motion value may be set directly to a value proportional to (or otherwise based on) the respective external control input. For example, if the human operator adjusts the sticks 1731 to indicate positive heave, e.g. ascending in the Z direction, then the c₀ motion value may be overwritten with a value based on the external heave control signal, and the other three motion values a₀, b₁, and a₁ may be left at their values computed in Step 1821. The algorithm may then perform Step 1823 using the resulting motion values. Finally, if at any time during the execution of algorithm 1801, it is detected that one of the external control signals is released back to neutral, for example if the human operator lets go of one of the control sticks, then the algorithm may reset by going back to Step 1813. This will cause the algorithm to initiate a hover in place in the air vehicle's new location.

Because of the dominating nature of yaw rate on many rotary wing air vehicles, it may be beneficial to further modify the second method of incorporating an external control signal so that if an external yaw signal is provided, for example a human is moving the control sticks 1731 to command a yaw turn, then all other motion values are zeroed out. This may prevent rapid yaw turns from causing erroneous motion values associated with the other types of motion (e.g. heave, X drift, and Y drift).

Fourth Exemplary Method for Vision Based Hover in Place

The fourth exemplary method for providing vision based hover in place to an air vehicle will now be discussed. The fourth exemplary method may be used in environments comprising an array of lights arranged around the environment. Such lights may be substantially point-sized lights formed by bright light emitting diodes (LEDs) or incandescent lights or other similar light sources. If the lights are the dominant sources of light in the environment, and when viewed by an image sensor appear substantially brighter than other texture in the environment, then it may be possible to compute image displacements by just tracking the location of the lights in the respective images of the image sensors. Will now discuss this variation in greater detail.

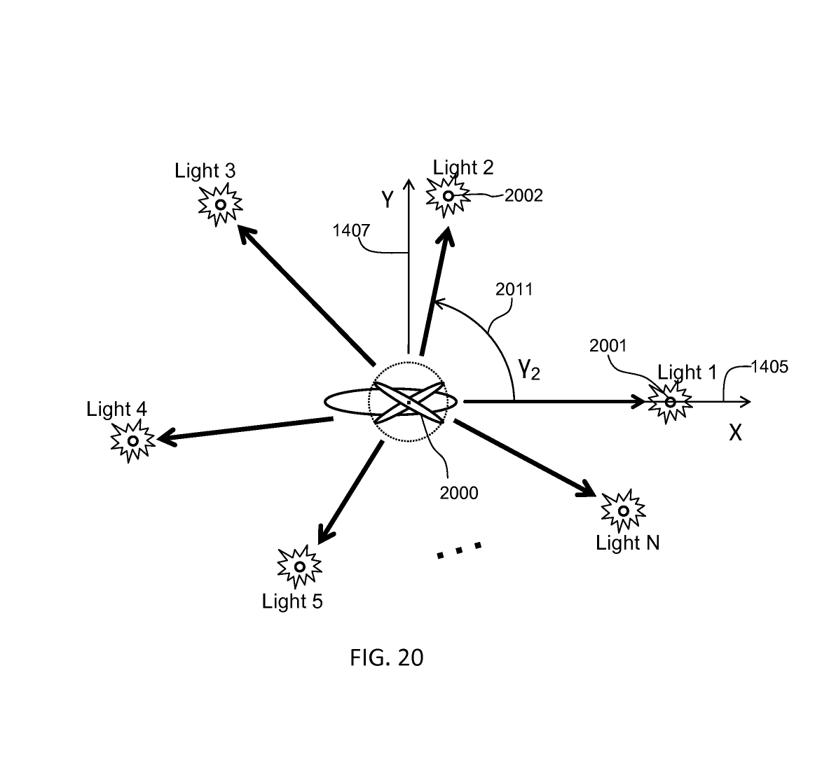

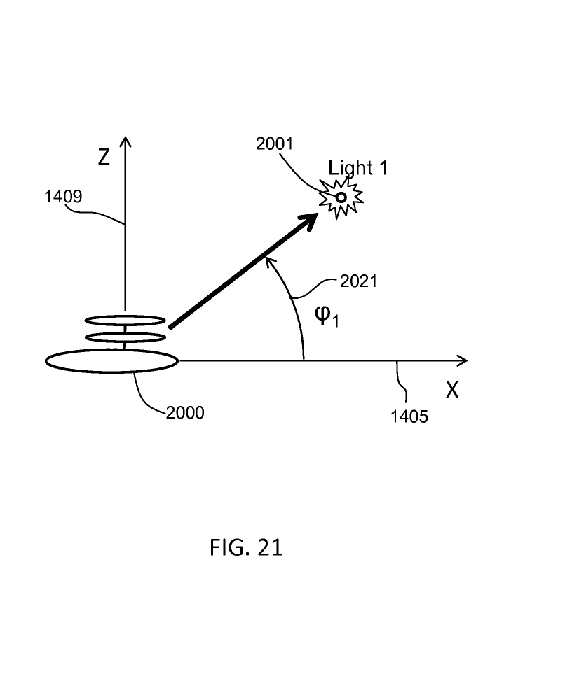

For purposes of discussion, let us assume the air vehicle is the same rotary wing platform to that discussed above (e.g. 1631), and that the air vehicle contains the same aforementioned exemplary vision based flight control system 1701. Refer to FIG. 20, which shows the top view of an air vehicle 2000 surrounded by a number of lights. The air vehicle 2000 and the lights are placed in the same coordinate system 1401 as FIG. 14. From this view, light 1 (2001) is aligned with the X-axis, while light 2 (2002) is located near the Y-axis. Let the angle γᵢ denote the azimuth angle (in the X-Y plane) of light j with respect to the positive X-axis. Thus in FIG. 20, γ₁=0 and γ₂ is the angle 2011 shown. Refer to FIG. 21, which shows a side-view of the same air vehicle 2000 and light 1 (2001) from the negative Y-axis. Let the angle φⱼ denote the elevation angle of light j above the X-Y plane. For example angle φ₁ (2021) is shown in FIG. 21.

The fourth exemplary method for vision based hover in place has the same steps as the second exemplary method, with the individual steps modified as follows: The first step 1811 is unchanged.

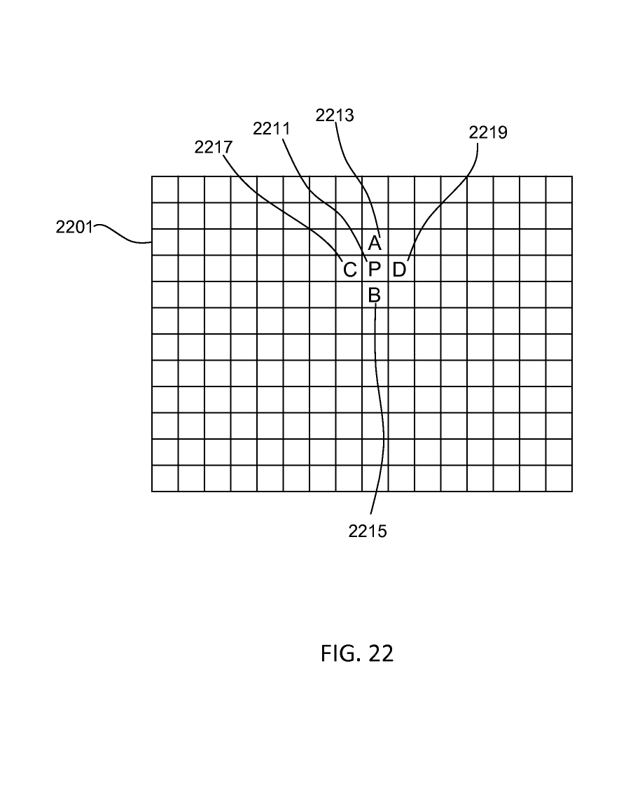

The second step 1813 modified as follows: the vision processor 1721 acquires the same image Rᵢ of 64×64 raw pixels from each sensor i. The image Rᵢ is then negated, so that more positive values correspond to brighter pixels. This may be performed by subtracting each pixel value from the highest possible pixel value that may be output by the ADC. For example, if a 12-bit ADC is used, which has 4096 possible values, each pixel value of Rᵢ may be replaced with 4096 minus the pixel value. For each image Rᵢ, the vision processor 1721 identifies the pixels associated with bright lights in the environment. Refer to FIG. 22, which shows a pixel grid 2201, a prospective bright light pixel P 2211, and it's four neighbors A 2213, B 2215, C 2217, and D 2219. A pixel P 2211 may be considered to be that of a bright light if the following conditions are met:

2P>A+B+θ₁;

2P>C+D+θ₁;

P>max(A,B,C,D); and

P>θ₂,

where A, B, C, D, and P denote the intensities of the respective pixel points 2213, 2215, 2217, 2219, and 2211. The first two conditions are a curvature test, and are measure of how much brighter P 2211 is than its four neighbors. The third condition tests whether P 2211 is brighter than all of its four neighbors. The fourth condition tests whether P 2211 is brighter than a predetermined threshold. All pixel points in the pixel array 2201 are provided the same test to identify pixels that may be associated with lights in the environment. Thresholds θ₁ and θ₂ may be empirically chosen and may depend on the size of the lights (e.g. 2001, 2002, and so on) in the environment as well as how much brighter these lights are than the background.

After all eight images have been processed, we will have a collection of L points of light (e.g. light pixels) obtained from these eight images. It will be understood that L does not need to equal eight, since the number of lights detected seen by each image sensor need not equal one. For each light pixel j (of the L light pixels), we compute the angles γᵢ and φⱼ based on the respective pixel location and the calibration parameters associated with the image sensor that acquired the pixel associated with light pixel j. Sample calibration parameters include the pose of each image sensor (e.g. roll, pitch, and yaw parameters with respect to the coordinate system 1401), the position of the optics over the image sensor, and any geometric distortions associated with the optics.

The third step 1815 is to initialize the position estimate. We set the values

γⱼ⁰=γⱼ and

φⱼ⁰=φⱼ;

for j=1, . . . L, where γⱼ⁰ and ωⱼ⁰ represent the “initial image information” or equivalently the initial locations of the lights. It will be understood that if the image sensors (e.g. 1611 through 1618) have overlapping fields of view, it is possible for the same physical light to be detected in more than one image sensor and thus be represented twice or more in the list of L lights.

The fourth step 1817 is to grab current image information from the visual scene. Essentially this may be performed by repeating the computations of the second step 1813 to extract a new set of light pixels corresponding to bright lights in the environment and thus extract a new set of values γₖ and φₖ. Note that the number of points may have changed if the air vehicle has moved adequately that one of the sensors detects more or fewer lights in its field of view.

The fifth step 1819 is to compute image displacements. Step 1819 may also be divided into three parts described next: In the first part 1861, we re-order the current points γₖ and φₖ so that they match up with the respective reference points γⱼ⁰ and φⱼ. Essentially for each current point γₖ and φₖ we may find the closest reference point γⱼ⁰ and φⱼ⁰ (using a distance metric) and re-index the current point as γᵢ and φⱼ. Note that the current points and the reference points may be in different order due to motion of the air vehicle. Also note that some lights may disappear and other lights may appear, also due to motion of the air vehicle. There may also be ambiguities due to two points crossing paths, also due to motion of the air vehicle. We define any point γᵢ and φᵢ and its matched reference point γⱼ⁰ and φⱼ⁰ as “unambiguous” if there is only one clear match between the two points, which additionally means that point γⱼ and φⱼ is not a new point.

The second part 1863 of step 1819 is to compute the actual image displacements. This may be performed by computing the following displacements for each unambiguous point γᵢ and φᵢ:

u₁=γⱼ−γⱼ⁰ and

vⱼ=(φⱼ−φⱼ⁰.

It will be understood that the number of unambiguous points γⱼ and φⱼ may be a number other than eight.

The third part 1865 of step 1819 is to update the list of reference points γⱼ⁰ and φⱼ⁰. Any such reference points that are matched up to an unambiguous point γⱼ and φⱼ may be left in the list of reference points. New points γⱼ and φⱼ that appeared in the current iteration of step 1817 may be added to the reference list. These correspond to points of light that appeared. Any points γⱼ⁰ and φⱼ⁰ that were not matched up may be removed from the reference list. These correspond to points of light that disappeared.

The sixth step 1821 and seventh step 1823 may be performed in the same manner as described above for the first exemplary method. The sixth step 1821 computes motion values from uⱼ and vⱼ, while the seventh step 1823 applies control to the air vehicle.

Note that the locations of the lights in images Rᵢ, as detected in step 2 1813 and step 4 1817, have a precision that corresponds to one pixel. Modifications may be made to these steps to further refine the position estimates to a sub-pixel precision. Recall again the point P 2211 and it's four neighbors in the pixel grid 2201. One refinement may be performed as follows: Let (m,n) denote the location of light point P 2211 in the pixel grid 2201, with m being the row estimate and n being the column estimate. If A>B, then use m−0.25 as the row estimate. If A<B, then use m+0.25 as the row estimate. If C>D, then use n−0.25 as the column estimate. If C<D, then use n+0.25 as the column estimate. These simple adjustments double the precision of the position estimate to one half a pixel.

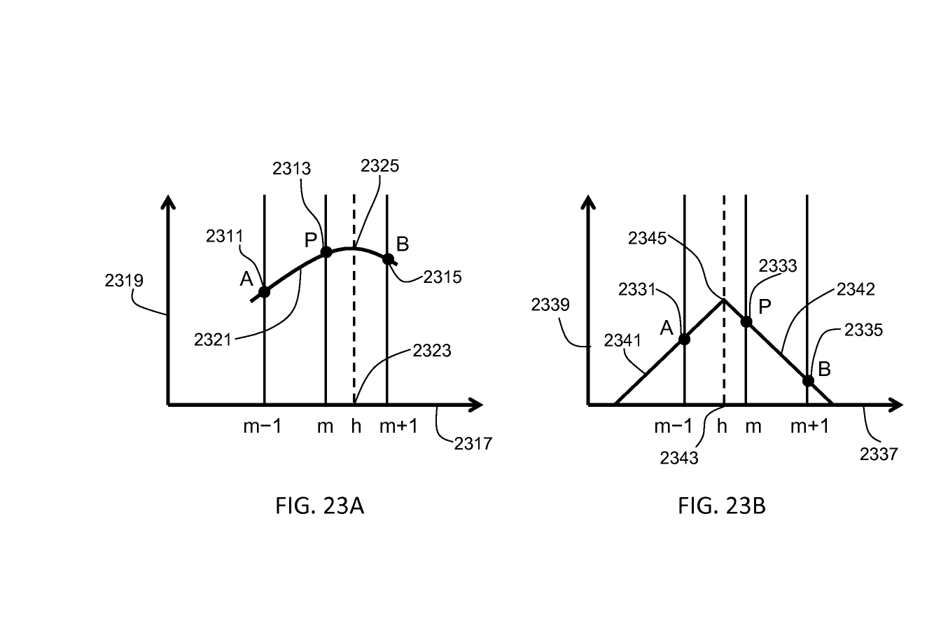

A further increase in precision may be obtained by using interpolation techniques which shall be described next. Refer to FIG. 23A, which shows subpixel refinement using polynomial interpolation. Let “m” refer to the row number associated with a light point P 2211 from FIG. 22. The light intensities 2311, 2313, and 2315 respectively of points A, P, and B may be plotted as a function of row number as shown in FIG. 23A with the row location on the X-axis 2317 and intensity on the Y-axis 2319. The three points 2311, 2313, and 2315 define a second order LaGrange polynomial 2321 that travels through the three points. The location h 2323 of the maxima 2325 of this polynomial may be computed by deriving the first derivative of the LaGrange polynomial 2321 and setting the first derivative equal to zero. The resulting value h 2323 on the X-axis 2317 that contains the maxima will thus be equal to:

$$h = m + \frac{B - A}{4 P - 2 A - 2 B}$$

The sub-pixel precision estimate of the row location may thus be given by the value of h. The sub-pixel precision estimate of the column location may be similarly computed using the same equation, but substituting m with n, A with C, and B with D, where n is the column location of point P.

It is also possible to obtain a sub-pixel precision estimate for the point P 2211 using a curve other than a LaGrange polynomial as used in FIG. 23A. Refer to FIG. 23B, which shows subpixel refinement using isosceles triangle interpolation. FIG. 23B is similar to FIG. 23A except that an isosceles triangle is used to interpolate between the three points 2331, 2333, and 2335 associated with A, P, and B. The isosceles triangle has a left side 2341 and a right side 2342. The slope of the left side 2341 is positive. The slope of the right side 2342 is equal to the negative of the slope of the left side 2341. If P 2333 is greater than A 2331 and B 2335, then only one isosceles triangle may be formed. The row location h 2343 of the apex 2345 may be computed using the following equations:

$$h = m + \frac{A - B}{2 ( A - P )} for B > A ;$$

$$h = m + \frac{A - B}{2 ( B - P )} for B < A ;$$

$$and$$

$$h = m for B = A .$$

The sub-pixel precision estimate of the column location may be similarly computed using the same equations, but substituting m with n, A with C, and B with D, where n is the column location of point P.

The use of either LaGrange interpolation or isosceles triangle interpolation may produce a more precise measurement of the light pixel location than using the simple A>B test. Which of these two methods is more accurate will depend on specifics such as the quality of the optics and the size of the lights. It is suggested that LaGrange interpolation be used when the quality of the optics is poor or if the lights are large. It is suggested that isosceles triangle interpolation be used when the images produced by the optics is sharp and when the lights are small in size.

Hover in Place for Samara Type Air Vehicles

Another type of rotary-wing air vehicle is known as a samara air vehicle. Samara air vehicles have the characteristic that the whole body may rotate, rather than just rotors. Effectively the rotor may be rigidly attached to the body as one rotating assembly. Examples of samara type air vehicles, and how they may be controlled and flown, may be found in the following papers, the contents of which shall be incorporated herein by reference: “From Falling to Flying: The Path to Powered Flight of a Robotic Samara Nano Air Vehicle” by Ulrich, Humbert, and Pines, in the journal Bioinspiration and Biomimetics Vol. 5 No. 4, published in 2010, “Control Model for Robotic Samara: Dynamics about a Coordinated Helical Turn”, by Ulrich, Faruque, Grauer, Pines, Humbert, and Hubbard in the AIAA Journal of Aircraft, 2010, and “Pitch and Heave Control of Robotic Samara Air Vehicles” in the AIAA Journal of Aircraft, Vol. 47, No. 4, 2010.

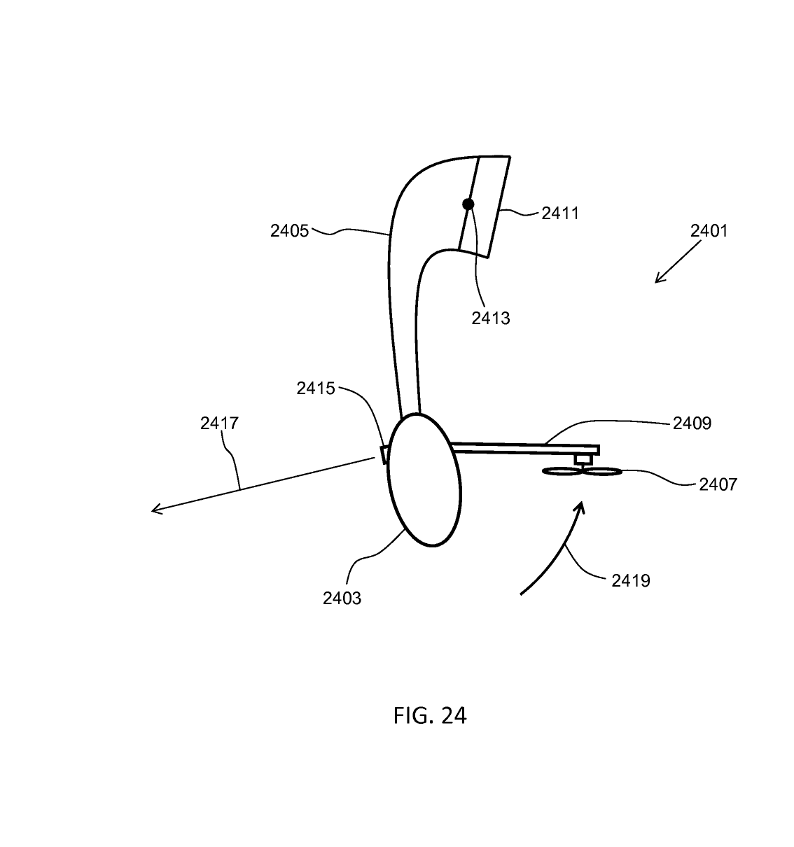

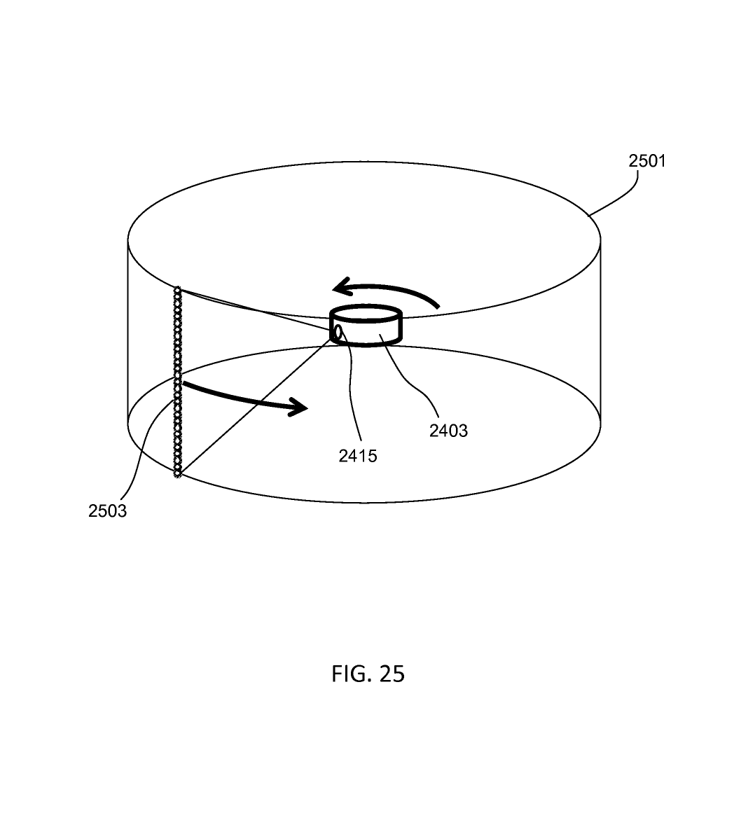

Refer to FIG. 24, which depicts an exemplary samara air vehicle 2401 based on the aforementioned papers by Humbert. The samara air vehicle 2401 contains a center body 2403, a rotor 2405, and a propeller 2407 attached to the body 2403 via a boom 2409. Attached to the rotor 2405 is a control flap 2411, whose pitch may be adjusted by a control actuator 2413. Also attached to the air vehicle 2401 is a vision sensor 2415 aiming outward in the direction 2417 shown. When the propeller 2407 spins, it causes the air vehicle 2401 to rotate counter clockwise in the direction 2419 shown. Alternative versions are possible. For example the aforementioned papers by Humbert describe a samara air vehicle where there is no separate control flap 2411, but instead the pitch of the entire rotor 2405 may be adjusted using a servo. A control processor integrated in the air vehicle 2401 may generate a signal to control the speed of the propeller 2407, causing the air vehicle 2401 to rotate. The same control processor may also generate a signal to control the pitch of the flap 2411 or the rotor 2405.

Since samara type air vehicles rotate, it is possible to obtain an omnidirectional image from a single vision sensor 2415 mounted on the air vehicle 2401. Refer to FIG. 25, which depicts an omnidirectional field of view 2501 that is detected using the vision sensor 2415. For simplicity, only the vision sensor 2415 and the body 2403 of the air vehicle 2401 are shown in FIG. 25. The vision sensor 2415 may be configured as a line imager, so that at any one instant in time it may detect a line image based on the line imager's field of view (e.g. 2503) as shown in FIG. 25. As the air vehicle 2401 rotates, so does the line field of view 2503 to scan out the omnidirectional field of view 2501.

In order to define a single image from the omnidirectional field of view 2501, it is possible to use a yaw angle trigger that indicates the air vehicle 2401 is at a certain yaw angle. This may be performed using a compass mounted on the air vehicle 2401 to detect it's yaw angle and a circuit or processor that detects when the air vehicle 2401 is oriented with a predetermined angle, such as North. The two dimensional image sweeped out by the vision sensor 2415 between two such yaw angle trigger events may be treated as an omnidirectional image. Sequential omnidirectional images may then be divided up into subimages based on the estimated angle with respect to the triggering yaw angle. Visual displacements and then motion values may then be computed from the subimages.

It is suggested that a modification of the aforementioned third exemplary method for providing hover in place be used to compute displacements and motion values and ultimately allow the air vehicle 2401 to hover in place. The modified third exemplary method may be described as follows, using FIG. 18A as a guideline: Step 1811 initializes any control rules, as described above but as appropriate for the samara air vehicle 2401.

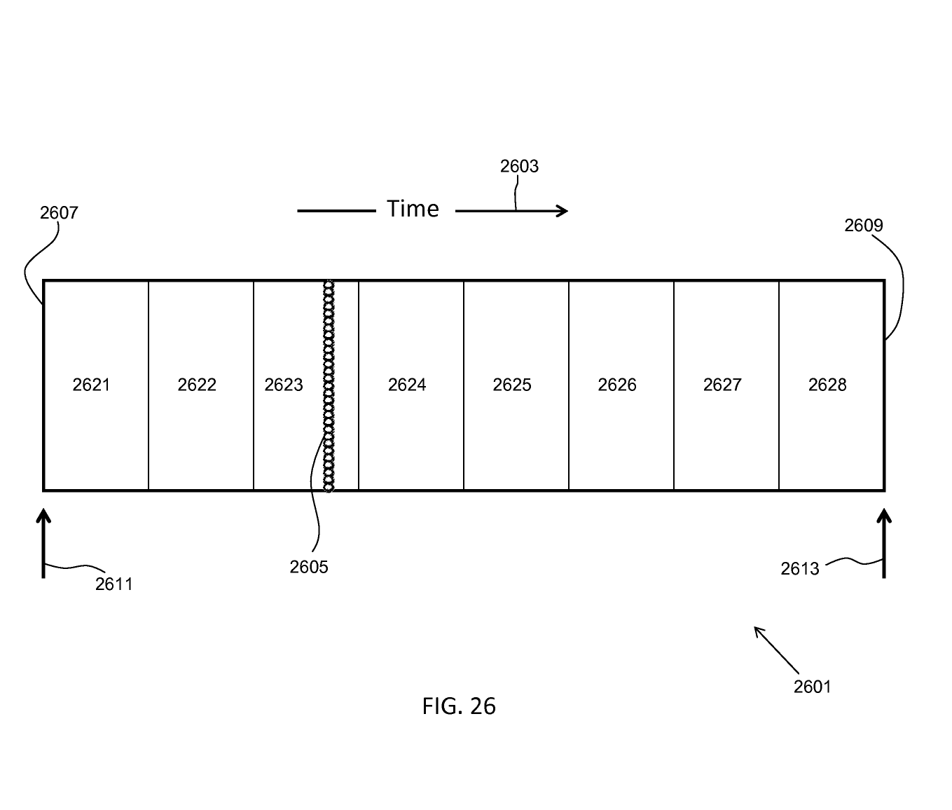

In Step 1813, initial image information is obtained from the visual scene. Refer to FIG. 26, which shows an omnidirectional image 2601 obtained from the vision sensor 2415 as the air vehicle 2401 rotates. This image 2601 may essentially be representative of the field of view 2501 but flattened with the time axis 2603 as shown. One column of the image (e.g. 2605) may be obtained by the vision sensor 2415 from one position, and is associated with a line field of view such as 2503. The left 2607 and right 2609 edges of the image 2601 may be defined by two sequential yaw angle triggerings 2611 and 2613. The image 2601 may then be divided into a fixed number of subimages, for example the eight subimages 2621 through 2628. It is beneficial for each subimage of the omnidirectional image 2601 have the same number of columns and either spaced evenly or placed directly adjacent to each other. Therefore it may be useful to discard columns of pixels at the end of the omnidirectional image 2601. Alternatively one may implement sub-pixel shifts and resampling to reconstruct the subimages at evenly spaced intervals. The implementation of sub-pixel shifts and resampling is a well known art in the field of image processing. These subimages may then be used to form the images J, and then processed as described above in the third exemplary algorithm.

The third step 1815 may be performed essentially the same as in the third exemplary method. The primary difference is that yaw angle is not a meaningful quantity to control since the samara air vehicle is constantly rotating and the yaw angle may already be determined by a compass. The fourth step 1817 may be performed in the same manner as the second step 1813 by grabbing a new and similar omnidirectional image and a new set of eight subimages Jᵢ.

Steps 1819, 1821, and 1823 may then be performed in the same manner as in the third exemplary method. In step 1823 the air vehicle 2401 may be controlled using any of the techniques described in the aforementioned papers by Humbert or any other appropriate methods.

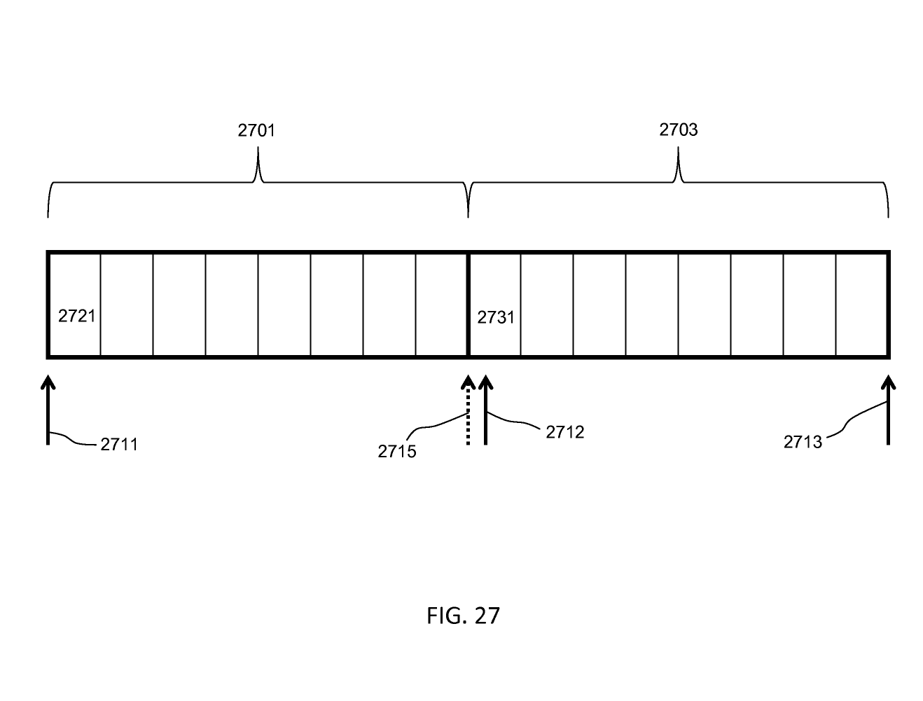

To handle situations in which the air vehicle 2401 is undergoing accelerations or decelerations in the yaw rate, a slight variation of the above techniques may be used. Refer to FIG. 27, which shows two sequential omnidirectional images 2701 and 2703 and their respective subimages. The two omnidirectional images 2701 and 2703 may be scanned out using the same techniques described above in FIGS. 25 and 26. These images may be defined by three yaw angle triggers 2711, 2712, and 2713. Since the air vehicle 2401 may be undergoing angular accelerations, the number of individual line images (e.g. 2605) and thus the number of columns between the first 2711 and second 2712 yaw angle triggers may be different than the number of columns between the second 2712 and third 2713 yaw angle triggers. In order for each omnidirectional image to have the same number of columns and thus the same number of pixels, it is possible to select the midpoint 2715 between the first 2711 and third 2713 yaw angle triggers as the boundary between the first 2701 and second 2703 omnidirectional images. If an odd number of columns were grabbed between the first 2711 and third 2713 yaw angle triggers, the last column may be discarded, or alternatively the two omnidirectional images may overlap by one column at the midpoint 2715. These two omnidirectional images 2701 and 2703 may then be divided into subimages as shown (for example subimage 2721 and it's corresponding sequential subimage 2731). Then in Step 1819 of the third exemplary algorithm, the image displacements uᵢ and vᵢ may be computed from the optical flow values between corresponding subimages, for example uᵢ and vᵢ from the two subimages 2721 and 2731. For the next iteration of the algorithm, a fourth yaw angle trigger may be detected, and two new omnidirectional subimages may be computed using the second 2712, third 2713, and fourth yaw trigger in the same manner.

Other variations of the algorithm may be considered. For example, it may be possible to apply sub-pixel warpings to the omnidirectional images (2601 or 2701 and 2703) to account for any angular acceleration or deceleration that occurs within one cycle. If an accurate and fast enough compass is used, the instantaneous yaw angle associated with each column (e.g. like 2605) may be used to compute similar sub-pixel shiftings that may be used to accordingly warp the subimages or adjust the measured image displacements. Finally other optical flow algorithms may be used, for example a block matching algorithm as described in the aforementioned second exemplary method of providing vision based hover in place.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method for controlling movement of a vehicle based upon visual information obtained from at least one vision sensor at a predetermined position on the vehicle, comprising the steps of:
determining a plurality of visual displacements based on the visual information representative of a reference position and a present position of the vehicle;
computing at least one motion value based on the plurality of displacements; and
generating at least one control signal based on the at least one motion value, wherein the control signal is capable of controlling the movement of the vehicle.

2. The method according to claim 1, further comprising the step of receiving external control information from an external control source, and wherein the at least one control signal is generated additionally based on the external control information.

3. The method according to claim 1, further comprising the steps of:
receiving a plurality of first images based upon the visual information; and
receiving a plurality of second images based upon the visual information, wherein the plurality of visual displacements is computed based on the plurality of first images and the plurality of second images.

4. The method according to claim 3, wherein each of the plurality of visual displacements is computed using an optical flow algorithm.

5. The method according to claim 1, wherein each visual displacement of the plurality of visual displacements is computing using the steps of:
resetting an accumulation;
receiving a first image based on the visual information;
receiving a second image based on the visual information;
computing a displacement between the first image and the second image;
adding the displacement to the accumulation; and
computing the visual displacement based on the accumulation.

6. The method according to claim 1, wherein each visual displacement of the plurality of visual displacements is computed using the steps of:
resetting an accumulation;
receiving a reference image based on the visual information;
receiving a current image based on the visual information;
computing a displacement between the reference image and the current image;
adding the displacement to the accumulation;
setting the reference image equal to the current image based on the displacement; and
computing the visual displacement based on the accumulation and the displacement.

7. The method according to claim 6, wherein the step of computing a displacement between the reference image and the current image further comprises algorithmically measuring sub-pixel displacements.

8. The method according to claim 6, wherein the step of computing displacement between the reference image and the current image further comprises the step of computing displacement of less than one pixel.

9. The method according to claim 1, wherein each visual displacement of the plurality of visual displacements is computed using the steps of:
selecting a reference patch of pixels based on the visual information;
computing a reference location based on the reference patch of pixels;
selecting a current patch of pixels based on the visual information and based on a match metric between the current patch of pixels and the reference patch of pixels;
computing a current location based on the current patch of pixels; and
computing the visual displacement based on the reference location and the current location.

10. The method according to claim 1, wherein:
the plurality of visual displacements is associated with a plurality of angular positions; and
each of the at least one motion values is computed additionally based on the plurality of angular positions.

11. The method according to claim 10, wherein the plurality of visual displacements is obtained from a plurality of vision sensors.

12. The method according to claim 1, wherein the field of view of the at least one vision sensor is at least 180 degrees.

13. The method according to claim 1, wherein the at least one control signal is capable of controlling the yaw angle of the vehicle.

14. The method according to claim 13, wherein the at least one control signal is capable of keeping the yaw angle of the vehicle substantially constant.

15. The method according to claim 13, wherein the at least one control signal is capable of controlling the pose angle of the vehicle.

16. The method according to claim 1, wherein the at least one control signal is capable of controlling the heave of the vehicle.

17. The method according to claim 16, wherein the at least one control signal is capable of controlling the position of the vehicle.

18. The method according to claim 17, wherein the at least one control signal is capable of keeping the position of the vehicle substantially constant.

19. The method according to claim 1, wherein the plurality of visual displacements is computed using the steps of:
detecting a plurality of reference light locations based on the visual information;
detecting a plurality of current light locations based on the visual information; and
computing the plurality of visual displacements based on the plurality of reference light locations and the plurality of current light locations.

20. The method according to claim 1, wherein the step of receiving visual information representative of a reference position and a present position of the vehicle comprises the steps of:
generating a signal capable of enabling the vehicle to rotate around an axis;
receiving a plurality of images based on the visual information; and
computing a plurality of two dimensional images based on the plurality of images, wherein
the visual information comprises the plurality of two dimensional images.

21. The method according to claim 20, further comprising a step of generating an angle signal based on the angle of the vehicle, wherein the plurality of two dimensional images is computed based additionally on the angle signal.

22. A program product for controlling movement of a vehicle based upon visual information obtained from at least one vision sensor at a predetermined position on the vehicle, the program product comprising executable code stored in at least one machine readable medium, wherein execution of the code by at least one programmable computer or processor causes the at least one programmable computer or processor to perform a sequence of steps, comprising:
determining a plurality of visual displacements based on the visual information representative of a reference position and a present position of the vehicle;
computing at least one motion value based on the plurality of displacements; and
generating at least one control signal based on the at least one motion value, wherein the control signal is capable of controlling the movement of the vehicle.

23. The program product according to claim 22, further comprising the step of receiving external control information from an external control source, and wherein the at least one control signal is generated additionally based on the external control information.

24. The program product according to claim 22, further comprising the steps of:
receiving a plurality of first images based upon the visual information;
receiving a plurality of second images based upon the visual information;
wherein the plurality of visual displacements is computed based on the plurality of first images and the plurality of second images.

25. The program product according to claim 24, wherein each of the plurality of visual displacements is computed using an optical flow algorithm.

26. The program product according to claim 22, wherein each visual displacement of the plurality of visual displacements is computing using the steps of:
resetting an accumulation;
receiving a first image based on the visual information;
receiving a second image based on the visual information;
computing a displacement between the first image and the second image;
adding the displacement to the accumulation; and
computing the visual displacement based on the accumulation.

27. The program product according to claim 22, wherein each visual displacement of the plurality of visual displacements is computed using the steps of:
resetting an accumulation;
receiving a reference image based on the visual information;
receiving a current image based on the visual information;
computing a displacement between the reference image and the current image;
adding the displacement to the accumulation;
setting the reference image equal to the current image based on the displacement; and
computing the visual displacement based on the accumulation and the displacement.

28. The program product according to claim 27, wherein the step of computing a displacement between the reference image and the current image further comprises algorithmically measuring sub-pixel displacements.

29. The program product according to claim 27, wherein the step of computing displacement between the reference image and the current image further comprises the step of computing displacement of less than one pixel.

30. The program product according to claim 22, wherein each visual displacement of the plurality of visual displacements is computed using the steps of:
selecting a reference patch of pixels based on the visual information;
computing a reference location based on the reference patch of pixels;
selecting a current patch of pixels based on the visual information and based on a match metric between the current patch of pixels and the reference patch of pixels;
computing a current location based on the current patch of pixels; and
computing the visual displacement based on the reference location and the current location.

31. The program product according to claim 22, wherein:
the plurality of visual displacements is associated with a plurality of angular positions; and
each of the at least one motion values is computed additionally based on the plurality of angular positions.

32. The program product according to claim 31, wherein the plurality of visual displacements is obtained from a plurality of vision sensors.

33. The program product according to claim 22, wherein the field of view of the at least one vision sensor is at least 180 degrees.

34. The program product according to claim 22, wherein the at least one control signal is capable of controlling the yaw angle of the vehicle.

35. The program product according to claim 34, wherein the at least one control signal is capable of keeping the yaw angle of the vehicle substantially constant.

36. The program product according to claim 34, wherein the at least one control signal is capable of controlling the pose angle of the vehicle.

37. The program product according to claim 22, wherein the at least one control signal is capable of controlling the heave of the vehicle.

38. The program product according to claim 37, wherein the at least one control signal is capable of controlling the position of the vehicle.

39. The program product according to claim 38, wherein the at least one control signal is capable of keeping the position of the vehicle substantially constant.

40. The program product according to claim 22, wherein the plurality of visual displacements is computed using the steps of:
detecting a plurality of reference light locations based on the visual information;
detecting a plurality of current light locations based on the visual information; and
computing the plurality of visual displacements based on the plurality of reference light locations and the plurality of current light locations.

41. The program product according to claim 22, wherein the step of receiving visual information representative of a reference position and a present position of the vehicle comprises the steps of:
generating a signal capable of enabling the vehicle to rotate around an axis;
receiving a plurality of images based on the visual information; and
computing a plurality of two dimensional images based on the plurality of images, wherein
the visual information comprises the plurality of two dimensional images.

42. The program product according to claim 41, further comprising a step of generating an angle signal based on the angle of the vehicle, wherein the plurality of two dimensional images is computed based additionally on the angle signal.
